(19) United States
(12) Patent Application Publication
(10) Pub. No.: US 2026/0171494 A1
(43) Pub. Date: Jun. 18, 2026

(54) MOLECULAR IONIC COMPOSITE ELECTROLYTES FOR SOLID-STATE BATTERIES

(71) Applicant: Virginia Tech Intellecual Properties, Inc., Blacksburg, VA (US)

(72) Inventors: Feng Lin, Christianburg, VA (US); Jungki Min, Blacksburg, VA (US); Louis A. Madsen, Blacksburg, VA (US)

(21) Appl. No.: 19/420,625

(22) Filed: Dec. 15, 2025

Related U.S. Application Data
(60) Provisional application No. 63/734,312, filed on Dec. 16, 2024.

(51) Int. Cl. H01M 10/0565; H01M 4/02; H01M 4/131; H01M 4/134; H01M 4/38; H01M 4/525

(52) U.S. Cl. CPC H01M 10/0565; H01M 4/131; H01M 4/134; H01M 4/382; H01M 4/525; H01M 2004/027; H01M 2004/028; H01M 2300/0082; H01M 2300/0085

(57) ABSTRACT

Disclosed herein are molecular ionic composite (MIC) polymer electrolytes. The MIC electrolytes described may be formulated to provide enhanced mechanical properties, improved ionic transport, and stable electrochemical performance across a broad temperature range. The compositions and methods presented are adaptable and may be tailored for various battery applications, including but not limited to solid-state lithium batteries or high-voltage lithium batteries.

### CROSS REFERENCE TO RELATED APPLICATION

This application claims priority to U.S. Provisional Patent Application No. 63/734,312, filed on Dec. 16, 2024, the content of which is hereby incorporated by reference in its entirety.

### FEDERAL RESEARCH STATEMENT

This invention was made with government support under Grant No. 683638 and under Grant No. DE-EE0008860, each awarded by the U.S. Department of Energy Office of Energy Efficiency and Renewable Energy (EERE). The government has certain rights in the invention.

### BACKGROUND

Solid-state batteries (SSBs) employing polymer electrolytes (PEs) can incorporate a lithium metal anode, enabling improved safety and higher energy density. PEs have received broad attention due to their excellent processibility, malleability, and intimate conformability with electrodes. Nevertheless, the wide application of PE-based SSBs is hampered by an array of interfacial issues, including resistive surface layer formation, Li dendrite growth, accretion of dead lithium, and parasitic side reactions at electrode-electrolyte interfaces. Unlike homogeneous polymer electrolytes, where ionic conductivity is reciprocally coupled to stiffness, multiphase polymer electrolytes can dramatically relax the coupling between these two antagonistic parameters. There has been a limited understanding of the interplay between chemistry and mechanics that drives any local phase transitions of PEs near the electrode-electrolyte interface.

Accordingly, there remains a continuing need in the art for improved polymer electrolyte compositions for solid-state batteries.

### SUMMARY

An aspect of the present disclosure is a composite electrolyte comprising: a sulfonated polyaramid; an ionic liquid; a dopant comprising an alkali metal salt; and an alkali metal salt additive that is different from the dopant and comprises an alkali metal phosphate salt, an alkali metal hexafluorophosphate salt, an alkali metal borate salt, an alkali metal tetrafluoroborate salt, or a combination thereof.

Another aspect is a method of making the composite electrolyte, the method comprising: casting an aqueous solution comprising the sulfonated polyaramid; the ionic liquid; the a dopant; and the alkali metal salt additive; to form a cast membrane; and drying the cast membrane to provide the composite electrolyte.

Another aspect is a battery comprising the composite electrolyte.

The above described and other features are exemplified by the following figures and detailed description.

### BRIEF DESCRIPTION OF THE DRAWINGS

The following figures are exemplary embodiments.

FIG. 1 is a schematic representation of the two-phase system in the molecular ionic composite (MIC) electrolyte.

FIG. 2 is a schematic showing synchrotron X-ray analysis of cross-sectional solid-state batteries, which combines X-ray fluorescence (XRF) microscopy and X-ray absorption spectroscopy (XAS) to visualize ionic concentration and probe chemical states across buried interfaces of solid-state battery components. Tracking the sulfur species of polymer electrolytes with XRF mapping reveals local ionic concentration heterogeneities, and spatially resolved XAS analysis informs the evolution of sulfur species from interfacial side reactions.

FIG. 3 shows voltage profiles of Li symmetric cells cycled at 23 and 60° C. with increasing steps of current density. The charge and discharge time is 0.5 h, respectively, with current density stepped every 10 cycles.

FIG. 4 shows long-term cycling stability of MIC and MIC with additive at 2.8-4.4 volts (V), C/3, and 60° C. Charge-discharge curves of 1st, 25th, 50th, and 100th cycles at 2.8-4.4 V, C/3, and 60° C.

FIG. 5 shows cycling performance of Li/MIC/NMC811 based on the cathode composed of 92% active material, 4% binder, and 4% carbon black.

FIG. 6 shows discharge curves of C/20, C/10, C/5, C/3, C/2, and 1C at 60° C. of MIC.

FIG. 7 shows cycling performance of Li/MIC/NMC811 based on the cathode composed of 92% active material, 4% binder, and 4% carbon black using the MIC with additive.

FIG. 8 discharge curves of C/20, C/10, C/5, C/3, C/2, and 1C at 60° C. of MIC with additive.

FIG. 9 shows a histogram of the sulfur fluorescence signal as sulfur fluorescence counts per pixel (X-axis) vs. Number of pixels (Y-axis) for pristine MIC. White scale bars are all 100 micrometers (μm).

FIG. 10 shows a histogram of the sulfur fluorescence signal as sulfur fluorescence counts per pixel (X-axis) vs. Number of pixels (Y-axis) for MIC (rested after cell assembly and disassembled). White scale bars are all 100 μm.

FIG. 11 shows a histogram of the sulfur fluorescence signal as sulfur fluorescence counts per pixel (X-axis) vs. Number of pixels (Y-axis) for MIC (8 cycles). White scale bars are all 100 μm.

FIG. 12 shows a histogram of the sulfur fluorescence signal as sulfur fluorescence counts per pixel (X-axis) vs. Number of pixels (Y-axis) for MIC (200 cycles). White scale bars are all 100 μm.

FIG. 13 shows an overlay of the histograms of FIG. 9-12.

FIG. 14 shows a plot of the sulfur fluorescence signal across the anode-electrolyte interface to the cathode-electrolyte interface as distance (X-axis) vs. sulfur fluorescence counts per pixel (Y-axis).

FIG. 15 shows XRF S mapping image and corresponding site-specific X-ray Absorption Near Edge Structure (XANES) spectra with the characteristic transitions of S for MIC (8 cycles, full cell cross section).

FIG. 16 shows XRF S mapping image and corresponding site-specific XANES spectra with the characteristic transitions of S for MIC (200 cycles, disassembled, electrolyte membrane only).

FIG. 17 shows atomic force microscopy (AFM) image in height maps and 3D representation of corresponding height maps of pristine MIC.

FIG. 18 shows atomic force microscopy (AFM) image in height maps and 3D representation of corresponding height maps of electrochemically cycled cathode-facing MIC.

FIG. 19 shows atomic force microscopy (AFM) image in height maps and 3D representation of corresponding height maps of anode-facing MIC.

FIG. 20 shows surface roughness profile of each AFM image of FIG. 17-19.

FIG. 21 shows a modulus plot of MIC membranes (The error bars indicate standard deviation obtained from 100 scanned regions).

FIG. 22 shows temperature-dependent diffusion coefficient plots of pristine MIC and MIC electrolyte after 200 cycles.

FIG. 23A shows combined X-ray fluorescence microscopy (XRF) and X-ray absorption spectroscopy (XAS) to evaluate the positive impact of additive on concentration and chemical heterogeneities. Tender energy X-ray synchrotron analysis enables structure and chemical interrogation of the role of the additive in the degradation of MIC electrolyte. The histogram of sulfur fluorescence signal is shown in a-b as sulfur fluorescence counts per pixel (X-axis) vs. number of pixels (Y-axis). White scale bars are all 50 μm.

FIG. 23B shows combined X-ray fluorescence microscopy (XRF) and X-ray absorption spectroscopy (XAS) to evaluate the positive impact of additive on concentration and chemical heterogeneities. Tender energy X-ray synchrotron analysis enables structure and chemical interrogation of the role of the additive in the degradation of MIC electrolyte. The histogram of sulfur fluorescence signal is shown in a-b as sulfur fluorescence counts per pixel (X-axis) vs. number of pixels (Y-axis). White scale bars are all 50 μm.

FIG. 24 shows a plot of the sulfur fluorescence signal across the anode-electrolyte interface to the cathode-electrolyte interface for MIC (100 cycles) and MIC with additive (100 cycles) (both in full cells).

FIG. 25 shows the set of XRF image, XANES spectra collected at Point A and scheme of cell components for MIC (100 cycles) and MIC with additive (100 cycles). The dashed box shows the energy range for the product from the reductive decomposition of sulfone and sulfonate species.

FIG. 26 shows chemical structures of the components of the designed MIC electrolytes according to an aspect of the present disclosure.

FIG. 27 shows a SEM image of as cast MIC membrane.

FIG. 28 shows dynamic mechanical thermal analysis (DMTA) of MIC membrane, showing minimal change in moduli from 25 to 300° C.

FIG. 29 shows thermogravimetric (TGA) analysis of an MIC membrane showing minimal decomposition up to 300° C.

FIG. 30 shows electrochemical impedance spectroscopy (EIS) measurements of designed MIC electrolytes according to an aspect.

FIG. 31A shows a chronoamperometry profile of designed MIC electrolytes at 23° C.

FIG. 31B shows a chronoamperometry profile of designed MIC electrolytes at 60° C.

FIG. 32 shows linear sweep voltammetry (LSV) plots of designed MIC electrolytes.

FIG. 33 shows nuclear magnetic resonance (NMR) diffusometry results of designed MIC electrolytes according to an aspect.

FIG. 34 shows voltage profiles of gen 1 MIC and designed MIC in Li symmetric cells cycled at 60° C. with increasing steps of current density. The charge and discharge time are 0.5 h, respectively, with current density stepped every 10 cycles. The inset shows enlarged voltage profiles from 147 h to 149 h. The Li symmetric cell of the designed MIC shows higher limiting current density with lower overpotential.

FIG. 35 shows a long-term voltage profile of Li symmetric cell from the designed MIC cycled at 60° C. with a current density of 0.3 milliampere per square centimeter (mA cm⁻²).

FIG. 36 shows long-term cycling stability of Li//NMC811 at 2.8-4.3V, C/3, and 60° C. based on the cathode composed of 92% active material, 4% binder, and 4% carbon black.

FIG. 37 shows long-term cycling stability of Li//NMC811 at 2.8-4.4V, C/3, and 60° C. based on the cathode composed of 92% active material, 4% binder, and 4% carbon black.

FIG. 38 shows chemical composition of MIC electrolytes highlighting the charged rigid-rod polymer, lithium salt, ionic liquid, solvent, and functional additive components. The asterisk (*) denotes components added to the baseline MIC formulation to achieve the NG-2 MIC electrolyte.

FIG. 39 shows ¹H, ¹⁹F, and ⁷Li diffusion coefficients of the NG-2 solid and NG-2 liquid. The solid NG-2 MIC membrane exhibits slower diffusion coefficients for all nuclei by a factor of 2 compared to the liquid components. This indicates that although the sample is solid, the polymer chains minimally hinders the ion transport, which is promising for solid-state electrolyte use.

FIG. 40 shows temperature dependence of the diffusion coefficients of the cation and anion of the IL in the NG-2 MIC compared to the Baseline MIC, noting a 21% improvement in ionic diffusivity for NG-2 MIC over the baseline MIC at 25° C.

FIG. 41 shows thermogravimetric analysis (TGA) revealing the thermal decomposition of the additives starting at 150° C., revealing a maximum temperature for the NG-2 MIC.

FIG. 42 shows representative stress-strain curves from three independent tests, confirming reproducible mechanical robustness of NG-2 MIC membranes collected at 30° C.

FIG. 43 shows potential profiles of Li∥Li symmetric cells cycled at 60° C. with increasing current density steps. The top panel shows the stepwise current density profile, where the current density increases every 10 cycles, with 0.5-hour charge and discharge times per step.

FIG. 44 shows long-term cycling stability of Li∥NMC811 coin cells at 2.8-4.4 V, C/3, and 60° C.

FIG. 45 shows potential profiles of the Li∥NMC811 cell recorded at the 1st, 50th, 100th, 200th, and 300th cycles under 2.8-4.4 V, C/3, and 60° C., illustrating capacity retention over extended cycling.

FIG. 46 shows rate capability profiles of the Li∥NMC811 cell at various specific current densities at 60° C., within a 2.8-4.4 V potential window.

FIG. 47 shows cycling performance of a Li∥NMC811 single-layer pouch cell at 2.8-4.4 V, C/3, and 60° C. and −1 MPa stack pressure.

FIG. 48 shows impedance spectra of Li∥NMC811 coin cells measured after a specific number of cycles under 2.8-4.4 V, C/3, and 60° C., showing the evolution of interfacial resistance.

FIG. 49 shows XPS spectra of C Is, providing insight into the chemical composition of the electrode-electrolyte interface.

FIG. 50 shows XPS spectra of F Is, providing insight into the chemical composition of the electrode-electrolyte interface

FIG. 51 shows XPS spectra of P 2p, providing insight into the chemical composition of the electrode-electrolyte interface

FIG. 52 shows depth-dependent intensity profiles of key secondary ion fragments (PO₃⁻, LiF₂⁻, SO₂⁻, C₅H₄N⁻, and C₆H₆O⁻) reveal the evolution of interphase composition as a function of depth.

FIG. 53 shows ion fragment intensity distributions at specific depths, providing insights into interphase composition.

FIG. 54A shows XRF maps and corresponding sulfur fluorescence histograms for NG-2 MIC in its pristine state.

FIG. 54B shows XRF maps and corresponding sulfur fluorescence histograms for NG-2 MIC after 200 cycles at C/3 (67 mA g⁻¹), 60° C., and 2.8-4.4 V.

FIG. 55 shows normalized sulfur fluorescence intensity profiles across electrodelelectrolyte interfaces (Li metallelectrolyte and electrolyte|NMC811). Data points represent averaged normalized fluorescence intensities, with shaded areas indicating standard deviations. The thicknesses of NG-2 MIC and baseline MIC electrolytes are 100 μm and 120 μm, respectively. Cycled samples were normalized to pristine counterparts to highlight sulfur redistribution clearly.

FIG. 56 shows sulfur (S) XRF mapping overlaid with a schematic of the Li∥NMC811 cell cross-section, highlighting the specific regions probed by XAS.

FIG. 57 shows site-specific sulfur K-edge X-ray Absorption Near Edge Structure (XANES) spectra from selected points (A: electrolyte|Li metal interface; B: bulk electrolyte; C: electrolyte|NMC811 interface), showing characteristic sulfur transitions. Point A indicates reductive decomposition products, whereas Point C highlights oxidative decomposition species. Reference spectra of elemental sulfur (S₈, gray) and pristine NG-2 MIC (cyan) are provided for comparison. Measurements utilized a 5 μm X-ray beam with a 15 μm probing depth. Ex situ analysis was performed on NG-2 MIC membranes harvested after 200 cycles at C/3 (67 mA g⁻¹), 60° C., and 2.8-4.4 V.

### DETAILED DESCRIPTION

The concentration heterogeneity, i.e., concentration polarization, can be a prime factor in understanding intricate dynamics in SSBs, affecting Li⁺ ion flux and degradation and/or phase transitions of PEs. The local concentration heterogeneity of various species can modulate the transport and mechanical properties of PEs, which can substantially impact the overall performance and stability of SSBs. The local concentration polarization of Li⁺ induces inhomogeneous current densities at the electrode-electrolyte interfaces, giving rise to localized hot spots for forming dendritic and dead lithium at the Li anode-PE interface. Another critical factor determining important aspects at SSB interfaces is chemical heterogeneity, i.e., the evolution of interphase from interfacial side reactions. Hence, it is imperative to track the evolution of concentration and chemical heterogeneities in PEs and directly visualize and analyze such heterogeneities in electrode-electrolyte interfaces of SSBs. Despite the significance of unveiling concentration and chemical heterogeneities at the interfaces, there have been limited analytical techniques to probe the buried interfaces with chemical and spatial specificity in a full-cell configuration. Meanwhile, such studies have been inhibited by the lack of a suitable model material platform.

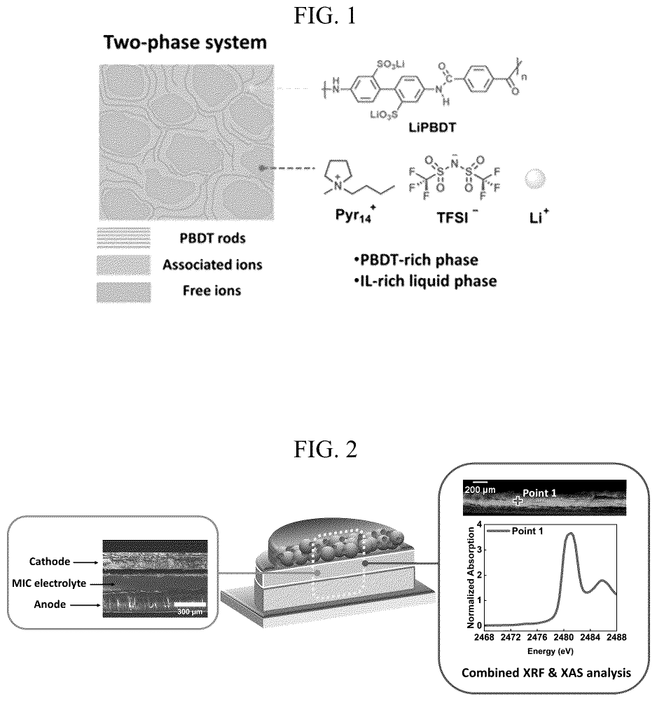

Molecular ionic composite (MIC) electrolytes are a unique class of PEs that concurrently accomplish robust mechanical properties and high ionic conductivity with a wide electrochemical stability window. The high modulus of MICs stems from the self-assembly of charged rigid-rod (and double helical) ionic polymer (poly-2,2′-disulfonyl-4,4′-benzidine terephthalamide, PBDT) with small cations and anions to form a collective electrostatic network. These associative interactions form a two-phase system in MICs electrolyte at specific weight percentages of PBDT polymer: PBDT-rich phase and IL-rich liquid phase, as shown schematically in FIG. 1. The two-phase system includes a co-continuous PBDT-rich phase and a liquid-like phase. The densely connected high-aspect ratio of PBDT rods with homogeneously distributed liquid-like phases is presented in MIC. Moreover, improved safety features of MIC are endowed by the non-flammability of the component ionic liquids (ILs), Li salts, and the aromatic polyamide PBDT. MICs have demonstrated their potential as a tailorable materials platform for solid-state electrolytes with a wide selection of components, e.g., lithium salts and ionic liquids.

The present inventors have discovered how heterogeneities of Li⁺ concentration and of various other chemical species near and across the electrode-electrolyte interface can underpin and drive interfacial phase separation of polymer electrolytes. The present inventors have further demonstrated that conventionally perceived “deformability” may not be sufficient to maintain intimate contact for PE-based SSB interfaces, especially when PEs undergo phase separation during electrochemical cycling. Furthermore, an interphase tailoring approach with functional additives to passivate interfaces has been explored, thereby suppressing concentration and chemical heterogeneities. A significant improvement is therefore provided by the present disclosure.

Accordingly, an aspect of the present disclosure is a composite electrolyte. The composite electrolyte comprises a sulfonated polyaramid; an ionic liquid; a dopant comprising an alkali metal salt; and a lithium salt additive. In addition to the lithium salt additive, the composite electrolyte can optionally further comprise one or more additional additives as further discussed herein. The additives according to the present disclosure can be selected to provide the composite electrolyte with enhanced cycling stability of high-voltage lithium metal batteries, compared to the same composite electrolyte not including the additive(s).

The sulfonated polyaramid of the present composite electrolyte can be a rigid rod polymer material. In an aspect, the sulfonated polyaramid comprises aramid repeating units of the general structure

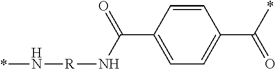

wherein R is a substituted or unsubstituted C₆₋₂₀ aromatic group, provided that at least a portion of the R groups are sulfonated (i.e., include —SO₃H or —SO₃⁻ substituent groups). The sulfonated polyaramid can include chemically modified derivatives and substituted versions of the foregoing chemical structure.

In an aspect, the sulfonated polyaramid can comprise poly(2,2′-disulfonyl-4,4′-benzidine terephthalamide), a substituted poly(2,2′-disulfonyl-4,4′-benzidine terephthalamide), a chemically modified poly(2,2′-disulfonyl-4,4′-benzidine terephthalamide), and combinations thereof. In an aspect, the sulfonated polyaramid can comprise poly(2,2′-disulfonyl-4,4′-benzidine terephthalamide), which comprises repeating units having the structure

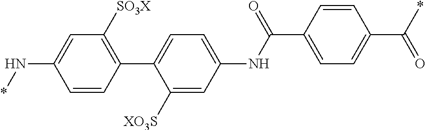

wherein X is hydrogen or an alkali metal.

The sulfonated polyaramid may be in the form of nanofibrils, which can have an average fibril diameter in the range of, for example, 1 to 30 nanometers (nm). In an aspect, the weight average molecular weight of the sulfonated aramid can be 100 to 10,000,000 grams per mole (g/mol), or 100 to 1,000,000 g/mol, or 100 to 100,000 g/mol, or 100 to 10,000 g/mol, or 10,000 to 10,000,000 g/mol, or 10,000 to 1,000,000 g/mol, or 10,000 to 100,000 g/mol, or 100,000 to 10,000,000 g/mol, or 100,000 to 1,000,000 g/mol. In a specific aspect, the sulfonated polyaramid can have a weight average molecular weight of 2,000 to 100,000 grams per mole, or 2,000 to 75,000 grams per mole, or 2,000 to 50,000 grams per mole, or 2,000 to 30,000 grams per mole. Molecular weight of the sulfonated polyaramid can be determined according to methods that are generally known, for example using sulfuric-acid-phase gel permeation chromatography coupled with capillary viscometry to determine relative molecular weight once the GPC benchmark is determined.

In some aspects, the sulfonated polyaramid is provided as an alkali metal salt, for example wherein X in the above formula is an alkali metal. The alkali metal can be, for example, sodium, lithium, potassium, cesium, or a combination thereof. In an aspect, the alkali metal can be sodium. In some aspects, the sulfonated polyaramid is provided as metal salt comprising a divalent metal cation. Exemplary divalent metal cations can include, but are not limited to, zinc, magnesium, calcium, barium, or a combination thereof.

The sulfonated polyaramid can be present in the composite electrolyte in an amount of 1 to 25 weight percent, based on the total weight of the composite electrolyte. Within this range, the sulfonated polyaramid can be present in an amount of at least 2 weight percent, or at least 5 weight percent, or at least 8 weight percent, or at least 10 weight percent, each based on the total weight of the composite electrolyte. Also within this range, the sulfonated polyaramid can be present in an amount of at most 20 weight percent, or at most 18 weight percent, or at most 15 weight percent, or at most 12 weight percent, each based on the total weight of the composite electrolyte. For example, the sulfonated polyaramid can be present in an amount of 1 to 20 weight percent, or 5 to 20 weight percent, or 5 to 18 weight percent, or 5 to 15 weight percent, or 8 to 12 weight percent, each based on the total weight of the composite electrolyte.

In addition to the sulfonated polyaramid, the composite electrolyte further comprises an ionic liquid, for example a room temperature ionic liquid. Ionic liquids, also referred to as molten salts because they are liquid at room temperature, e.g., 23° C., can have low volatility, for example a vapor pressure of less than 10⁻⁵ Pascal (Pa), or 10⁻¹⁰ to 10⁻⁵ Pa at a temperature of 23° C.

The ionic liquid includes an anion component and a cation component. The anion of the ionic liquid can include, but is not limited to, one or more of halide, sulfate, sulfonate, carbonate, bicarbonate, phosphate, nitrate, nitrate, acetate, PF₆, BF₄, trifluoromethanesulfonate (triflate), nonaflate, bis(trifluoromethylsulfonyl)amide, bis(fluorosulfonyl)imide, bis(trifluoromethanesulfonyl)imide, trifluoroacetate, heptafluororobutanoate, haloaluminate, triazolide, or an amino acid derivative (e.g., proline with the proton on the nitrogen removed). The cation of the ionic liquid can include, but is not limited to, one or more of imidazolium, pyridinium, pyrrolidinium, phosphonium, ammonium, sulfonium, thiazolium, pyrazolium, piperidinium, triazolium, pyrazolium, oxazolium, guanidinium, dialkylmorpholinium, an alkylated derivative of any of the foregoing (e.g., alkylated with a C₁₋₁₂ alkyl group (e.g., ethyl, propyl, butyl, hexyl, or the like)), or an alkali metal cation. In some aspects, the cation can be imidazolium, pyridinium, pyrrolidinium, or an alkylated derivative thereof, for example, wherein the cation is alkylated with a C₁₋₁₂ alkyl group (e.g., ethyl, propyl, butyl, hexyl, or the like). In an aspect, the room temperature ionic liquid includes a pyrrolidinium as a cation component, preferably an alkylated derivative thereof. In an aspect, the room temperature ionic liquid can include 1-butyl-1-methylpyrrolidinium as a cation component. In an aspect, the room temperature ionic liquid can include bis(trifluoromethylsulfonyl)imide (“TFSI”) as an anion component. In an aspect, the room temperature ionic liquid can be 1-butyl-1-methylpyrrolidinium bis(trifluoromethyl sulfonyl)imide.

The ionic liquid can be present in the composite electrolyte in an amount of 20 to 95 weight percent, based on the total weight of the composite electrolyte. Within this range, the ionic liquid can be present in an amount of at least 25 weight percent, or at least 30 weight percent, or at least 35 weight percent, or at least 40 weight percent, or at least 45 weight percent, or at least 50 weight percent, or at least 55 weight percent, or at least 60 weight percent, or at least 65 weight percent, or at least 70 weight percent, or at least 75 weight percent, or at least 80 weight percent, each based on the total weight of the composite electrolyte. Also within this range, the ionic liquid can be present in an amount of at most 90 weight percent, or at most 85 weight percent, or at most 80 weight percent, or at most 75 weight percent, or at most 70 weight percent, or at most 65 weight percent, or at most 60 weight percent, or at most 50 weight percent, each based on the total weight of the composite electrolyte. For example, the ionic liquid can be present in an amount of 25 to 95 weight percent, or 25 to 90 weight percent, or 40 to 90 weight percent, or 50 to 90 weight percent, or 50 to 80 weight percent, or 50 to 70 weight percent, or 55 to 65 weight percent, or 60 to 90 weight percent, or 70 to 90 weight percent, or 75 to 85 weight percent, each based on the total weight of the composite electrolyte.

In addition to the sulfonated polyaramid and the ionic liquid, the composite electrolyte further comprises a dopant comprising an alkali metal salt. The dopant may include a lithium, sodium, or other alkali metal salt. Preferably, the dopant comprises a lithium salt. Exemplary dopants can include, but are not limited to, lithium bis(trifluoromethanesulfonyl)imide (LiTFSI), lithium bis(fluorosulfonyl)imide (LiFSI), lithium trifluoromethanesulfonate (LiTf), lithium perchlorate (LiClO₄), sodium bis(trifluoromethanesulfonyl)imide (NaTFSI), sodium bis(fluorosulfonyl)imide (NaFSI), magnesium bis(trifluoromethanesulfonyl)imide (MgTFSI₂), or aluminum tris(trifluoromethanesulfonyl)imide (Al(TFSI)₃), or a combination thereof. In some aspects, the dopant excludes borate salts, fluoroborate salts, phosphate salts, and fluorophosphate salts, preferably lithium phosphate salts, lithium fluorophosphate salts, lithium borate salts, lithium fluoroborate salts, or a combination thereof. In a specific aspect, the dopant can comprise lithium bis(trifluoromethyl sulfonyl)imide having the structure

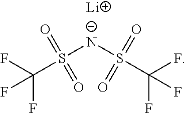 [SMILES: [Li+] ; O=S(=O)([N-]S(=O)(=O)C(F)(F)F)C(F)(F)F]

The dopant can be present in the composite electrolyte in an amount of 1 to 25 weight percent, based on the total weight of the composite electrolyte. Within this range, the dopant can be present in an amount of at least 2 weight percent, or at least 5 weight percent, or at least 8 weight percent or at least 10 weight percent, each based on the total weight of the composite electrolyte. Also within this range, the dopant can be present in an amount of at most 20 weight percent, or at most 18 weight percent, or at most 15 weight percent, or at most 12 weight percent, or at most 10 weight percent, each based on the total weight of the composite electrolyte. For example, the dopant can be present in an amount of 1 to 20 weight percent, or 5 to 20 weight percent, or 5 to 15 weight percent, or 5 to 12 weight percent, or 8 to 12 weight percent, each based on the total weight of the composite electrolyte.

In addition to the sulfonated polyaramid, the ionic liquid, and the dopant, the composite electrolyte further comprises an alkali metal additive, for example a lithium salt additive. The alkali metal additive (e.g., the lithium salt additive) is distinct from the above-described dopant. Specifically, the alkali metal additive can comprise, or be selected from the group consisting of, an alkali metal phosphate salt, an alkali metal fluorophosphate salt, an alkali metal borate salt, an alkali metal fluoroborate salt, or a combination thereof. Alkali metals such as lithium and sodium are mentioned. In an aspect, the alkali metal additive can be a lithium salt additive and can comprise, or be selected from, a lithium phosphate salt, a lithium fluorophosphate salt, a lithium borate salt, a lithium fluoroborate salt, or a combination thereof. The alkali metal salt additive may be included to improve interfacial stability, enhance electrode compatibility, reduce interfacial resistance, or suppress dendrite formation at the electrode-electrolyte interface.

Suitable lithium salt additives include, but are not limited to, lithium difluorobis(oxalato)phosphate (LiDFBOP), lithium difluorophosphate (LiDFP), lithium phosphate (Li₃PO₄), lithium difluoro(oxalato)borate (LiDFOB), lithium bis(oxalato)borate (LiBOB), and lithium tetrafluoroborate (LiBF₄), as well as combinations thereof. In a specific aspect, the lithium salt additive can comprise a lithium oxalate-containing salt, such as lithium difluorobis(oxalato) phosphate, lithium difluoro(oxalato)borate, lithium bis(oxalato)borate, or a combination thereof, preferably lithium difluoro(oxalate)borate or lithium difluorobis(oxalate) phosphate.

Additional lithium salts not specifically provided for herein may be excluded from the present composite electrolyte. For example, the composite electrolyte of the present disclosure can be substantially free of, or exclude, a lithium halide salt (e.g., lithium chloride, lithium bromide, or lithium iodide), and a lithium organohalide salt (e.g., lithium difluoroacetate or lithium trifluoroacetate). As used herein, the term “substantially free of” means that the composite electrolyte includes less than 5 weight percent, or less than 1 weight percent, or less than 0.1 weight percent of indicated component, based on the total weight of the composite electrolyte. Preferably, the composite electrolyte of the present disclosure excludes the foregoing lithium halide salts or lithium organohalide salts.

The lithium salt additive can be present in the composite electrolyte in an amount of 0.1 to 10 weight percent, based on the total weight of the composite electrolyte. Within this range, the lithium salt additive can be present in an amount of at least 0.5 weight percent, or at least 1 weight percent, or at least 2 weight percent, or at least 5 weight percent, each based on the total weight of the composite electrolyte. Also within this range, the lithium salt additive can be present in an amount of at most 8 weight percent, or at most 6 weight percent, or at most 5 weight percent, each based on the total weight of the composite electrolyte. For example, the lithium salt additive can be present in an amount of 0.5 to 10 weight percent, or 1 to 10 weight percent, or 1 to 8 weight percent, or 1 to 5 weight percent, each based on the total weight of the composite electrolyte.

In addition to the sulfonated polyaramid, the ionic liquid, the dopant, and the lithium salt additive, the composite electrolyte can optionally further comprise one or more additives.

In an aspect, the composite electrolyte can further comprise a sulfur-containing polar aprotic solvent. Exemplary sulfur-containing polar aprotic solvents can include, but are not limited to, sulfolane, (tetramethylene sulfone), ethyl methyl sulfone, dimethyl sulfone, 1,3-propane sultone, or a combination thereof. In a specific aspect, the sulfur-containing polar aprotic solvent can comprise sulfolane.

When present, the sulfur-containing polar aprotic solvent can be included in the composite electrolyte in an amount of 5 to 50 weight percent, based on the total weight of the composite electrolyte. For example, the sulfur-containing polar aprotic solvent can be present in an amount of 5 to 45 weight percent, or 10 to 50 weight percent, or 10 to 45 weight percent, or 10 to 40 weight percent, or 10 to 35 weight percent, or 10 to 30 weight percent, or 10 to 25 weight percent, or 5 to 25 weight percent, each based on the total weight of the composite electrolyte.

The composite electrolyte can further optionally include an additive comprising an oligoether compound. As used herein, the term “oligoether compound” refers to a compound comprising a backbone of two or more ether-linked alkylene oxide units, optionally terminated with alkyl or aryl groups. Suitable oligoether compounds include, but are not limited to, tetraethylene glycol dimethyl ether, triethylene glycol dimethyl ether, diethylene glycol dimethyl ether, dimethoxy ethane, polyethylene glycol dimethyl ether, or a combination thereof. The oligoether compound can have a molecular weight ranging from 100 g/mol to 1,000 g/mol. Higher molecular weight polyethylene glycol dimethyl ethers are also contemplated by the present disclosure.

When present, the oligoether compound can be included in the composite electrolyte in an amount of 1 to 20 weight percent, based on the total weight of the composite electrolyte. For example, the oligoether compound can be present in an amount of 1 to 15 weight percent, or 1 to 12 weight percent, or 1 to 10 weight percent, each based on the total weight of the composite electrolyte.

Each of the sulfur-containing polar aprotic solvent and the oligoether compound can be used individually in the composite electrolyte or in combination.

In an aspect, the composite electrolyte can be a solid at a temperature of 25 to 200° C.

In an aspect, the composite electrolyte can comprise 1 to 25 weight percent of the sulfonated polyaramid; 20 to 95 weight percent of the ionic liquid; 1 to 25 weight percent of the dopant; and 0.1 to 10 weight percent of the lithium salt additive; wherein weight percent is based on the total weight of the composite electrolyte.

In a specific aspect, the composite electrolyte can comprise 5 to 15 weight percent of the sulfonated polyaramid; 70 to 90 weight percent of the ionic liquid; 5 to 15 weight percent of the dopant; and 1 to 8 weight percent of the lithium salt additive. The sulfonated polyaramid can comprise poly(2,2′-disulfonyl-4,4′-benzidine terephthalamide) or a derivative thereof. The ionic liquid can comprise 1-butyl-1-methylpyrrolidinium bis(trifluoromethyl sulfonyl)imide. The dopant can comprise lithium bis(trifluoromethyl sulfonyl)imide. The lithium salt additive can comprise lithium difluoro(oxalate)borate.

In another specific aspect, the composite electrolyte can comprise 5 to 15 weight percent of the sulfonated polyaramid; 50 to 70 weight percent of the ionic liquid; 5 to 15 weight percent of the dopant; 1 to 5 weight percent of the lithium salt additive; and 15 to 30 weight percent of a sulfur-containing polar aprotic solvent. The sulfonated polyaramid can comprise poly(2,2′-disulfonyl-4,4′-benzidine terephthalamide) or a derivative thereof. The ionic liquid can comprise 1-butyl-1-methylpyrrolidinium bis(trifluoromethyl sulfonyl)imide. The dopant can comprise lithium bis(trifluoromethyl sulfonyl)imide. The lithium salt additive can comprise lithium difluorobis(oxalate) phosphate. The sulfur-containing polar aprotic solvent can comprise sulfolane.

In another specific aspect, the composite electrolyte can comprise 5 to 15 weight percent of the sulfonated polyaramid; 50 to 70 weight percent of the ionic liquid; 5 to 15 weight percent of the dopant; 1 to 5 weight percent of the lithium salt additive; 10 to 25 weight percent of a sulfur-containing polar aprotic solvent; and 1 to 15 weight percent of an oligoether compound. The sulfonated polyaramid can comprise poly(2,2′-disulfonyl-4,4′-benzidine terephthalamide) or a derivative thereof. The ionic liquid can comprise 1-butyl-1-methylpyrrolidinium bis(trifluoromethyl sulfonyl)imide. The dopant can comprise lithium bis(trifluoromethyl sulfonyl)imide. The lithium salt additive can comprise lithium difluorobis(oxalate) phosphate. The sulfur-containing polar aprotic solvent can comprise sulfolane. The oligoether compound can comprise tetraethylene glycol dimethyl ether.

It will be understood that the amounts of the components of the composition sum to 100 weight percent in any given aspect.

The composite electrolyte of the present disclosure can exhibit one or more desirable properties. For example, the composite electrolyte can exhibit an ionic conductivity of 1×10⁻⁶ to 1.5×10⁻² S/cm at 23° C. The composite electrolyte can exhibit a storage modulus of 100 to 1000 MPa at 25° C. The composite electrolyte can exhibit a loss modulus of 10 to 100 MPa at 25° C.

A method for the manufacture of the composite electrolyte represents another aspect of the present disclosure. The method comprises casting an aqueous or mixed solvent (e.g., water and a water-miscible organic solvent such as N,N-dimethylformamide) solution comprising the sulfonated polyaramid; the ionic liquid; the a dopant; the lithium salt additive; and, when present, the sulfur-containing polar aprotic solvent, the oligoether compound, or both. Casting the solution provides a cast membrane. In some aspects, the aqueous solution can be heated prior to casting, for example to a temperature of at least 70° C., such as 75 to 100° C. The method further comprises drying the cast membrane to provide the composite electrolyte. Drying the cast membrane can be under conditions effective to remove solvent (e.g., water and optionally an organic solvent, if present). For example, drying the cast membrane can be at elevated temperature such as 70 to 120° C., or 80 to 100° C. Exemplary methods for the manufacture of the composite electrolyte are further described in the working examples provided herein.

The composite electrolytes of the present disclosure can be particularly useful in a battery, for example a solid-state battery. The battery of the present disclosure can comprise an anode, a cathode, and the composite electrolyte disposed between the anode and the cathode.

The anode can be constructed from a variety of materials, including, but not limited to, graphite, activated carbon, carbon nanotubes, graphene, lithium metal (e.g., lithium foil), and combinations thereof. In some aspects, the anode can comprise lithium metal, which may be provided in the form of a foil, sheet, or other suitable configuration. The lithium metal anode is advantageous for solid-state lithium-ion batteries due to its high theoretical capacity and low electrochemical potential, which enable increased energy density and improved battery performance.

Alternatively, the anode can comprise carbon-based materials, such as graphite, activated carbon, carbon nanotubes, or graphene. These materials may be used individually or in combination, and may be provided in various forms, including powders, films, fibers, or composites. The selection of anode material may be based on desired battery characteristics, such as capacity, cycle life, safety, and compatibility with the solid-state electrolyte.

The anode can optionally further include additional components or coatings to enhance interfacial stability, suppress dendrite formation, or improve compatibility with the solid-state electrolyte. Such components may include protective layers, passivation coatings, or interfacial modifiers, which may be applied by physical, chemical, or electrochemical methods.

In some aspects, the anode can be configured to interface directly with the composite electrolyte of the present disclosure. The anode and electrolyte may be arranged in contact to facilitate lithium-ion transport during charge and discharge cycles. The anode may be shaped, sized, or otherwise adapted to suit the intended battery architecture, including coin cells, pouch cells, prismatic cells, or other formats.

The cathode can be constructed from a wide range of materials suitable for use in batteries, including, but not limited to, transition metal oxides, phosphates, sulfides, fluorides, or composite materials thereof. Exemplary cathode materials include lithium cobalt oxide (LiCoO₂), lithium manganese oxide (LiMn₂O₄), lithium iron phosphate (LiFePO₄), lithium nickel manganese cobalt oxide (LiNiₓMn_{y}Co_{z}O₂), lithium nickel cobalt aluminum oxide (LiNiₓCo_{y}Al_{z}O2), and other lithium-containing compounds. The cathode material can be provided in various forms, such as powders, films, fibers, or composites, and may be combined with conductive additives, binders, or coatings to enhance electronic conductivity, mechanical integrity, and interfacial compatibility with the composite electrolyte.

In an aspect, the cathode can comprise a lithium nickel manganese cobalt oxide material, preferably LiNi_{0.8}Mn_{0.1}Co_{0.1}O₂ (commonly referred to as NMC811). This material is advantageous for high-energy solid-state lithium-ion batteries due to its high specific capacity, thermal stability, and favorable electrochemical performance. The cathode may further include additional components or surface treatments to improve cycle life, suppress side reactions, or enhance compatibility with the composite electrolyte. The cathode may be configured to interface directly with the composite electrolyte and may be shaped, sized, or otherwise adapted to suit the intended battery architecture, including coin cells, pouch cells, prismatic cells, or other formats.

In addition to the anode, cathode, and composite electrolyte, a battery may include various other components and features that are generally known in the art. These may include, for example, separators, current collectors, cell housings or encapsulation structures, interfacial layers or coatings, thermal management elements, pressure application mechanisms, electrical connections or terminals, safety devices, and monitoring or control electronics. The selection, configuration, and integration of such components may be tailored according to the intended battery architecture and application, and may employ any suitable materials or methods consistent with established practices in the field.

The battery including the composite electrolyte can exhibit one or more desirable properties. For example, the battery can exhibit an initial discharge capacity of 150 to 250 milliampere-hour per gram (mAh/g) at a temperature of 60° C. and at a C-rate of C/3. As used herein, “battery capacity” or “capacity” refers to the amount of energy a battery can hold. Battery capacity can be measured by discharging a battery at a specific current until the “end of discharge voltage” (EODV). The EODV is a specific voltage at which battery discharge is terminated and may vary by battery type, intended operating conditions, and the like. As used herein, a “C-rate” relates to charge and discharge rate of a battery. C-rates are typically represented as multiples or fractions of 1C (the one hour discharge rate). Thus, a C-rate of C/2 (also represented as 0.5C) is a two-hour discharge rate and a C-rate of 2C is a 30-minute discharge rate.

The battery can exhibit a discharge capacity retention of at least 80%, or at least 85%, or at least 90% measured over 100 cycles or over 500 cycles at a temperature of 60° C. and at C/3. The term “capacity retention” is expressed as a percentage and refers to the amount of battery capacity retained after a given number of cycles. Capacity retention may vary based on battery operating temperature and other factors, with actual capacity retention being lower when a battery is operated at a higher temperature.

In some aspects, the battery can be charged and discharged over a voltage range of 2.8 to 4.4 V or over a voltage range of 2.8 to 4.3 V. In some aspects, the battery can exhibit a limiting current density of greater than 0.5 mA cm-2.

This disclosure is further illustrated by the following examples, which are non-limiting.

### Examples

Insights into concentration and chemical heterogeneities were obtained using combined synchrotron X-ray fluorescence (XRF) microscopy and X-ray absorption spectroscopy (XAS) with high spatial resolution for these buried interfaces in the full-cell SSB configuration (FIG. 2). This study demonstrates that conventionally perceived “deformability” may not be sufficient to maintain intimate contact for PE-based SSB interfaces, especially when PEs undergo phase separation during electrochemical cycling.

For the following examples, molecular ionic composite (MIC) membranes were prepared according to the following general procedure. The baseline MIC electrolyte was prepared by dissolving 120 mg of LiPBDT in 12 g of H₂O. 120 mg of LiTFSI and 960 mg of Pyr₁₄TFSI were dissolved in 12 g of DMF (“MIC with additive” was prepared by the further addition of 60 mg LiDFOB). After heating the two separate solutions to 80° C. inside the oven overnight, they were mixed and equilibrated at 80° C. over another night. The mixed solution was cast on a 10×10 cm² glass plate and dried overnight at 80° C. in the oven, to evaporate the solvents. The MIC membrane was further dried at 100° C. in a vacuum oven for 2 days. The MIC membrane was peeled off the glass substrate and punched into 19 mm disks with ˜100 μm thickness.

### Performance of MIC Electrolyte-Based Li-Metal Cells

MICs represent a novel type of solid electrolyte material made from collective electrostatic interactions between the charged-rigid rod PBDT polymer and small mobile ions from ILs and lithium salts. These collective associative interactions give rise to a conductive nanofibrillar “bundle” phase, which creates MICs that contain only a single phase at 20 to 25 weight percent (wt %) PBDT. If the PBDT content is less than 20 weight percent (wt %), MICs are a two phase system, with the above-mentioned bundle phase co-continuous with an IL/salt-rich liquid phase that has a characteristic length scale of <100 nm. MICs have showcased the tunability of mechanical properties and ionic conductivities by incorporating a wide selection of ILs and lithium salts. For battery electrolyte applications, MICs with PBDT content of 10 wt % provide a materials platform for investigating interfacial degradation behavior in multiphase polymer electrolyte systems.

The MIC electrolyte membrane used in the present examples included 10 wt % PBDT polymer with 10 wt % lithium bis(trifluoromethylsulfonyl)imide (LiTFSI), and 80 wt % 1-butyl-1-methylpyrrolidinium bis(trifluoromethylsulfonyl)imide (Pyr₁₄TFSI). Based on the compositional tunability of MICs, 4.8 wt % lithium difluoro(oxalate)borate (LiDFOB) of lithium salt is incorporated into the MIC electrolyte as a functional additive for better cycling performance and termed as “MIC with additive”. This material has the following composition: LiPBDT/LiTFSI/Pyr₁₄TFSI/LiDFOB in wt % of 9.5:9.5:76.2:4.8.

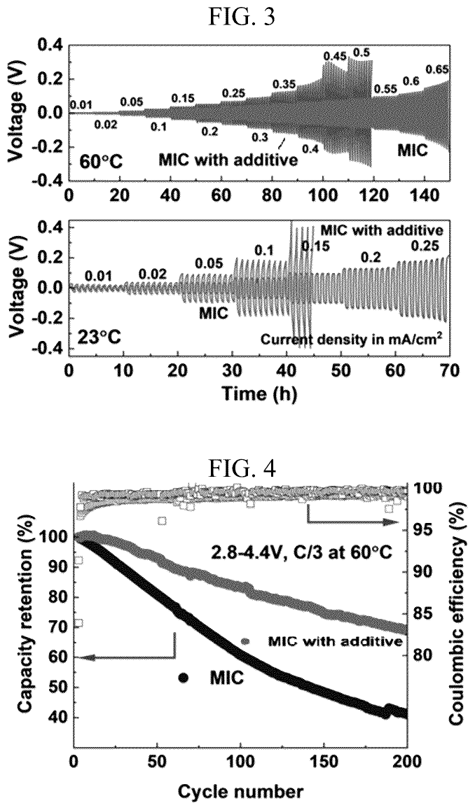

The Li symmetric cells were cycled at 23° C. and 60° C. as a function of (stepped) current density to evaluate the compatibility between MIC membrane and Li metal (FIG. 3). The voltage response of Li|Li symmetric cells at 23° C. indicates the limiting current density with the base MIC electrolyte to be 0.15 mA cm⁻² and with the modified MIC with the additive to be 0.25 mA cm⁻². At 23° C., the MIC with additive showed lower overpotential throughout Li stripping and plating than the MIC (96 mV vs. 403 mV at 0.15 mA cm⁻²). The lower overpotential and higher limiting current density of the MIC with additive at 23° C. suggest that a more stable interphase forms. At 60° C., the limiting current density of the MIC is 0.65 mA cm⁻², and the MIC with additive is 0.5 mA cm⁻². The moderate limiting current density of MIC with additive compared to MIC may stem from the thickened passivation layer at 60° C., which contributes to resistance and impedes efficient lithium plating and stripping. Li symmetric cells at constant current density showed long-term cycling stability at 60° C., lasting over 500 h.

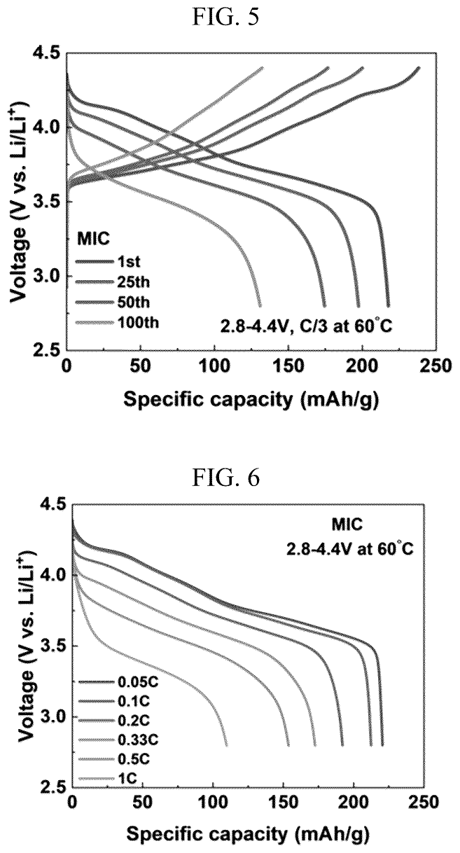

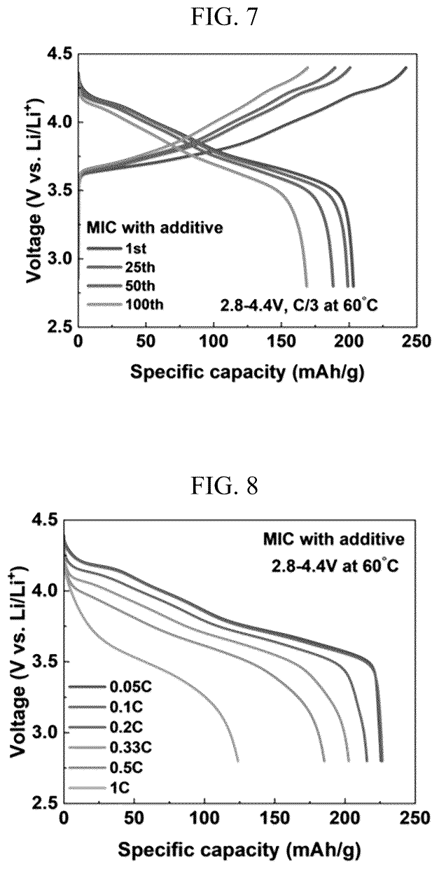

Based on the high ionic conductivity, mechanical strength, and superior thermal stability of MIC electrolytes, Li|MIC|LiNi_{0.8}Co_{0.1}Mn_{0.1}O₂(NMC811) full cells were assembled to evaluate electrochemical performance. FIG. 4 compares MIC-based full cells and MIC with additive-based full cells with a cutoff voltage of 4.4V at 60° C. for 200 cycles. The capacity retention after 200 cycles for MIC with additive and MIC full cells are 70% and 40%, respectively, demonstrating a beneficial effect of functional additive in stabilizing battery performance. FIG. 5 shows the galvanostatic charge-discharge curves of the full cell with a cutoff voltage of 4.4V at 60° C., which delivers a high discharge specific capacity of 217 mAh g⁻¹ at C/3 and capacity retention of 60% after 100 cycles. FIG. 6 shows the rate performance of the full cell with increasing current density from 0.05C to 1C. The full cell exhibited a high specific capacity of 220 mAh g⁻¹ at 0.05C, and 110 mAh g⁻¹ at 1C. FIG. 7 shows galvanostatic charge-discharge curves of the full cell with MIC with additive at 60° C., delivering a high discharge specific capacity of 203 mAh g⁻¹ at C/3, and a capacity retention of 83% after 100 cycles. The lower initial capacity of MIC with additive compared to MIC is ascribed to passivation from LiDFOB decomposition, which increases the impedance not only for the battery cycling (so lower capacity for one with additive) but also increasing the impedance (kinetic barrier) for the side reaction. FIG. 8 shows the rate performance of the full cell with MIC with additive, exhibiting a high specific discharge capacity of 185.28 mAh g⁻¹ at 0.5C, which is 17.1% higher than MIC-based full cell at 0.5C.

Unlike in Li symmetric cells, the MIC with additive performed better in Li//NMC811 full cells, ascribed to the passivation layer from LiDFOB, stabilizing the cathode-electrolyte interface. Based on findings from electrochemical studies of MIC and MIC with additive, two MIC materials were investigated for chemomechanical phenomena in each full cell using synchrotron X-ray analyses.

### Concentration Heterogeneity at the Electrode-Electrolyte Interface

The XRF microscopy enabled sulfur elemental mapping on cross-sections of the MIC electrolytes, unveiling the distribution of sulfur species therein. The sulfonate group (—SO₃⁻) of the rigid rod polymer and the sulfone group (—SO₂) of the TFSI⁻ anion from the ionic liquid and lithium salt contribute to the sulfur fluorescence signal. Considering the significant portion of mobile ions (from both ionic liquid and lithium salt) in the MIC electrolyte (90 wt %), the sulfur fluorescence signal is dominated by the TFSI⁻ anion. Hence, the mobile ion concentration in the MIC electrolyte can be directly visualized by XRF mapping, which can also reflect Li⁺ concentration inferred from the charge-balancing counterion (TFSI⁻).

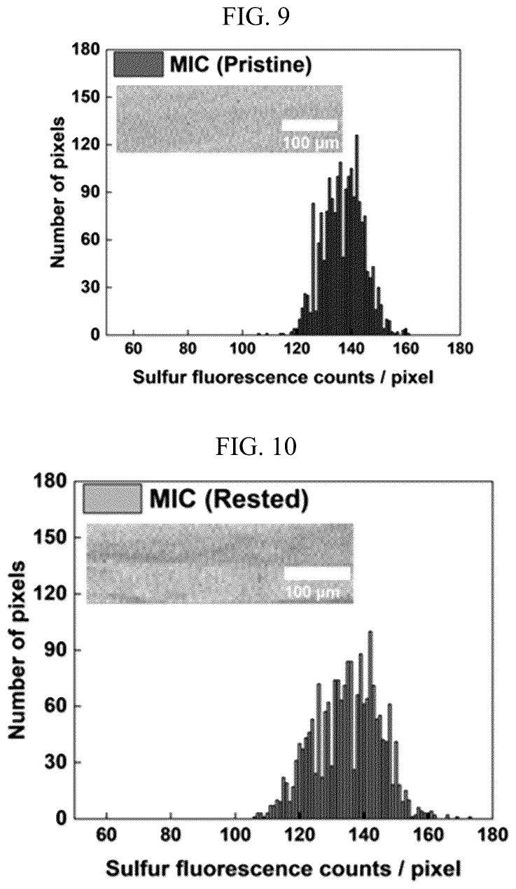

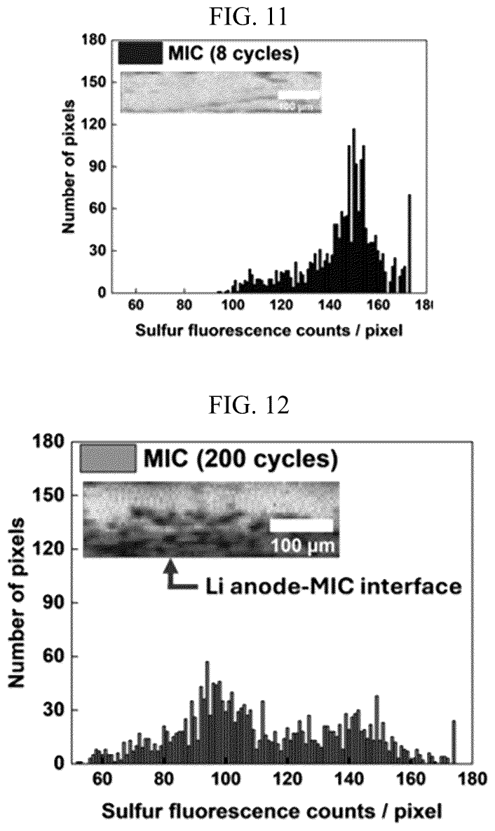

FIG. 9-12 display sulfur XRF images of cross-sectioned samples with different electrochemical cycling histories, and the largest representative area from the scanned XRF image of each sample is chosen. The sulfur fluorescence counts per pixel (X-axis) vs. the number of pixels (Y-axis) are plotted to compare each sample's ionic concentration distribution, which signals the degree of concentration heterogeneity. Moreover, the histogram area corresponds to the total intensity of the sulfur fluorescence signal obtained from the XRF image. The pristine MIC electrolyte displays a uniform distribution of mobile ions with a narrow range of sulfur fluorescence counts per pixel (FIG. 9). The cross-sectional XRF image of the MIC membrane harvested from the assembled coin cell rested at 60° C. for 1 day is shown in FIG. 10. Comparing FIG. 9 and FIG. 10, it is clear that the pressure applied during cell assembly alone does not cause substantial depletion of mobile ion concentration at the electrode-electrolyte interface. In FIG. 11, after 8 cycles, the MIC membrane displays a wide distribution of sulfur fluorescence intensity compared to pristine MIC, and MIC rested for 1 day. This change in the distribution of sulfur fluorescence intensity of the MIC membrane may indicate the onset of concentration heterogeneity from electrochemical cycling.

After 200 cycles, in FIG. 12, the concentration heterogeneity of the MIC membrane increases substantially. The observed concentration heterogeneity may likely result from a disruption in MIC's two-phase system, which begins from the decomposition of rigid-rod ionic PBDT polymer at the electrode-electrolyte interfaces.

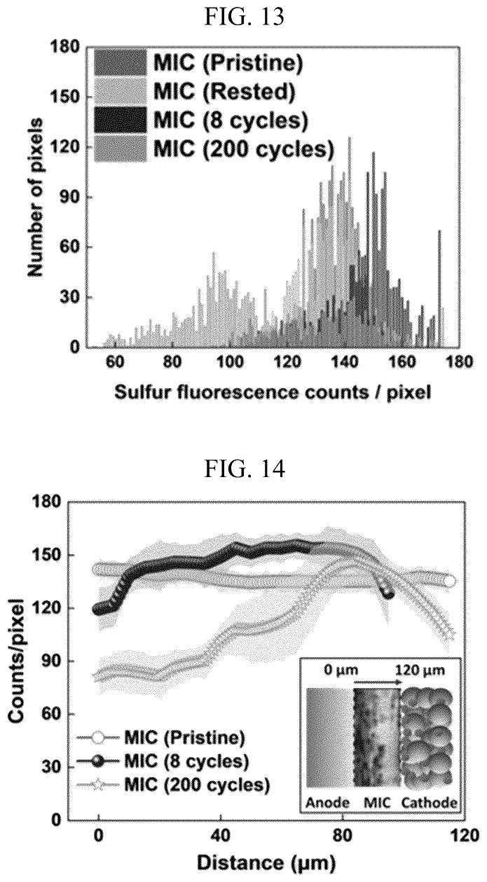

The notable discrepancy between the XRF image of the pristine MIC and MIC (200 cycles) sample suggests that a cumulative concentration heterogeneity occurred throughout the extensive electrochemical cycling (FIG. 12). Considering that the area of the histogram between MIC (pristine) and MIC (200 cycles) is unchanged, it is likely that the sulfur species are heterogeneously redistributed rather than extracted outward from the MIC membrane. Furthermore, the scanning electron microscopy (SEM) images of the cross-sectional cycled MIC membranes showed a clear edge with preserved thickness. The synchrotron micro-compute tomography (μ-CT) revealed no discernable pores inside pristine or cycled MIC membranes, supporting that the concentration heterogeneity observed in XRF images does not originate from void, dead lithium or lithium dendrite. Localized regions depleted of sulfur fluorescence signal are particularly evident at the interfaces, especially at the Li metal anode-MIC electrolyte interface (FIG. 12). The overlay of the histogram from cross-sectional MIC samples indicates that sulfur fluorescence intensity becomes widely distributed after battery cycling, signaling the concentration heterogeneity (FIG. 13).

The severe local concentration heterogeneity at the electrode-electrolyte interface imposes constraints in uniform Li⁺ flux, ensuing nonuniform current density. As a consequence, this concentration nonuniformity at the interface induces localized ‘hot spots,’ intensifying the degradation of polymer electrolytes, promoting lithium dendrite growth, and facilitating the formation of dead lithium at the Li anode-MIC electrolyte interface, leading to rapid capacity decay. In addition, the concentration heterogeneity brings about phase transition in MICs electrolytes by disrupting inherent “PBDT-rich” and “IL-rich” phases, thereby undermining the mechanical integrity of the polymer electrolyte membrane. Consequently, the erratic population of low-sulfur fluorescence domains prevailing at electrode-electrolyte interfaces manifests an ensemble of chemical and mechanical degradation of polymer electrolytes.

The line profile analysis provides further insights into changes in ion concentration as a function of distance from a specific interface, as shown in FIG. 14 with distance from the anode-electrolyte interface (X-axis) vs. sulfur fluorescence counts per pixel (Y-axis). The uniform ion concentration distribution in pristine MIC is shown as a plateau in counts per pixel, irrespective of location (FIG. 14). In the sulfur fluorescence intensity line profile of MIC (8 cycles), a decrease in the sulfur fluorescence counts per pixel is observed at the anode-electrolyte interface (X=0-10 μm) and cathode-electrolyte interface (X=90-100 μm), presumably due to the disintegration of two-phases from side reaction with electrodes. The MIC (200 cycles) sample showed drastic changes in sulfur fluorescence counts per pixel along the direction between two interfaces (FIG. 14). This amplified inhomogeneous sulfur fluorescence intensity across the MIC (200 cycles) suggests that concentration heterogeneity initiated at the electrode-electrolyte interfaces eventually propagates toward the bulk of the MIC electrolyte. FIG. 14 shows a notable decrease in the sulfur fluorescence counts per pixel at the anode-electrolyte interface spanning the bulk region (X=0-90 μm). The prominent concentration heterogeneity at the Li anode-electrolyte interface indicates the pronounced disintegration of two phases in the MIC electrolyte. Concentration heterogeneity is displayed throughout the 30 μm region (X=90-120 μm) for the cathode-electrolyte interface. Considering the degree of concentration heterogeneity observed in line profile analysis, the Li anode-electrolyte interface is more pronounced with phase separation. The observed concentration heterogeneity may likely result from a disruption in MIC's two-phase system, which begins from the decomposition of rigid-rod ionic PBDT polymer at a highly reactive Li metal anode interface. Moreover, the degree of concentration heterogeneity is relevant to the upper cut-off voltage of the cycling condition, which aligns with our proposed decomposition pathways. The high voltage cycling accelerates the decomposition of charged rigid-rod PBDT polymer into short oligomers and byproducts that no longer maintain the uniform distribution of liquid-like phase in the two-phase system.

### Chemical Heterogeneity as an Evolution of Interphase

The sulfur K-edge XAS directly probes the chemical nature of sulfur within the cross-sectional sample by studying the characteristic transitions corresponding to different sulfur species. Combined with the XRF mapping, the point scanning XAS on cross-sectional samples allowed site-specific probing of sulfur chemical states, particularly across electrode-electrolyte interfaces. Based on the XRF image from the cross-section of the full-cell, the XAS analysis discovered the emergence of new sulfur species at the electrode-electrolyte interfaces, which is not feasible with XPS analysis.

The preliminary XAS investigation on the MIC electrolyte and its components aligned with previous reports of sulfur X-ray absorption near edge structure (XANES) results. The MIC electrolyte features a broad maximum at 2480.5 eV, a composite of sulfone and sulfonate groups.

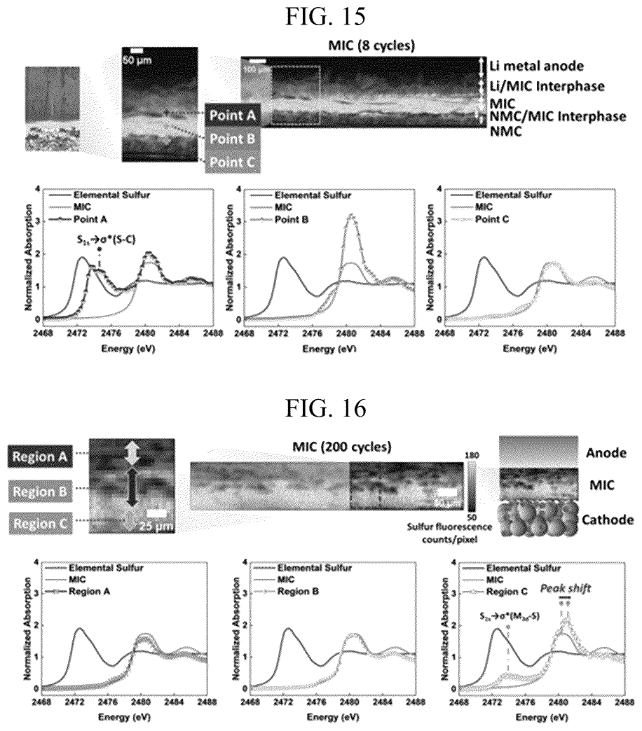

The present inventors conducted XAS analysis on MIC (8 cycles) sample in full cell configuration (FIG. 15). From point A, the lowest-energy feature at 2473.9 eV is assigned as the S1s→σa*(S-C) transition, which signals low-valent sulfur species (FIG. 15). This energy feature substantiates the reductive decomposition of the MIC electrolyte at the interface with the Li metal anode, attributed to sulfide species, as suggested in the reaction pathway. Other types of new sulfur species are not observed in points B and C, possibly due to the low cycle numbers (8 cycles).

For the MIC (200 cycles) sample, synchrotron analysis is conducted on the MIC membrane independently, not in full cell configuration (FIG. 16). From Region C in MIC (200 cycles), a feature at 2482.0 eV is observed and attributed to high-valent sulfur species, i.e., S⁶⁺ as SO₄²⁻ (sulfate).

In addition, the marginal feature at 2473.6 eV, at region C of the cathode-electrolyte interface, corresponds to the transition metal chelated to the sulfonate group of MICs electrolyte, i.e., S₁ₛ→σ*(M_{3d}-S). However, despite the long cycle numbers, the reductively decomposed sulfur species are not observed in the sample. Initially, we assumed that the XANES feature corresponding to reductive decomposition might have been lost during the harvesting of the MIC membrane from the battery cell. However, XANES spectra corresponding to reductive decomposition are observed in other membrane-only samples, indicating that cross-sectional membrane samples are sufficient to probe interphase evolution as long as enough point scans are conducted.

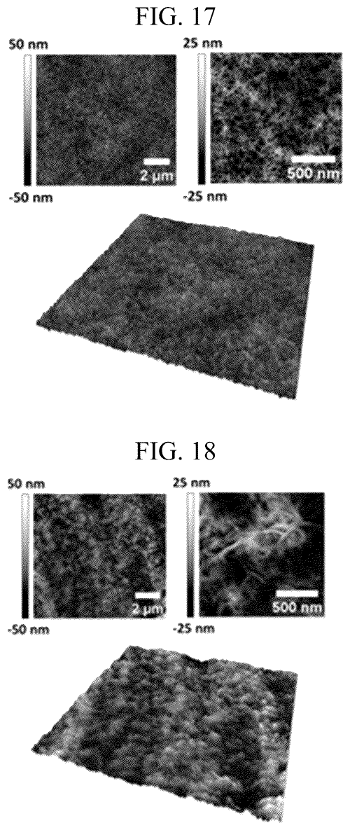

Along with the concentration heterogeneity, chemical heterogeneity accounts for the degradation of polymer electrolytes at the electrode-electrolyte interface, undermining the structural integrity and transport properties of the polymer electrolyte membrane (FIG. 17). The spatially resolved XAS analysis on the corresponding sulfur fluorescence image informs the evolution of interphase in a statistically wide field of view on the cross-sectional SSBs, providing additional insights into interfacial chemical speciation. The concentration and chemical heterogeneity are also observed in other common types of polymer electrolytes, suggesting that interfacial heterogeneity is a universal phenomenon.

### Morphological Evolution and Ion Transport Behavior of MICs

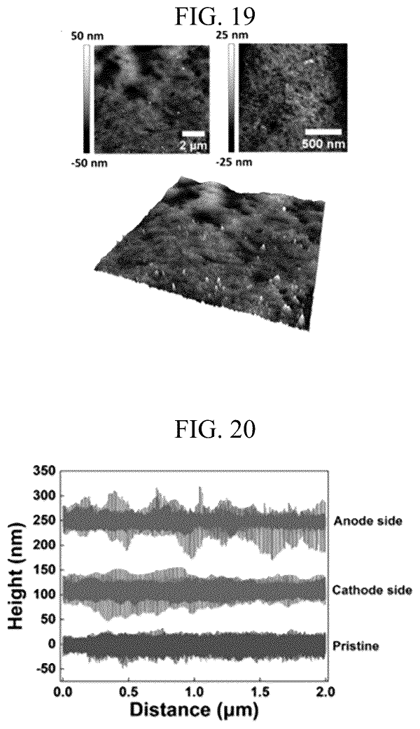

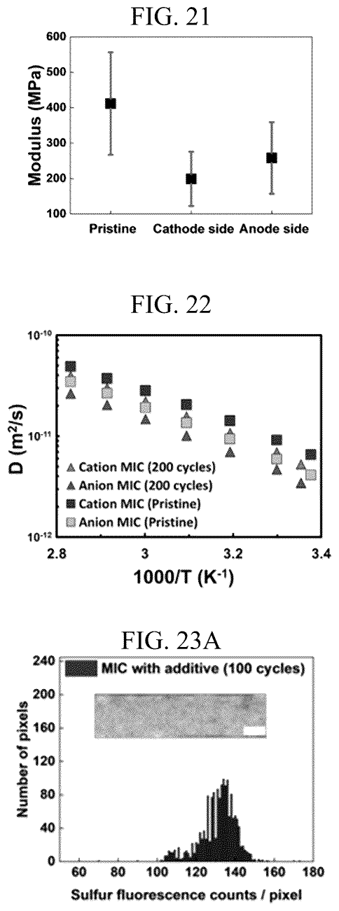

MIC electrolytes' surface morphology and diffusion properties were investigated to understand interfacial phase separation. The characteristic internal microstructure of MIC and its evolution after electrochemical cycling with respect to specific electrode/electrolyte interface is studied by atomic force microscopy (AFM). FIG. 17-19 show the topographic image of the pristine, cathode-facing, and anode-facing sides of the MIC membrane, where bright and dark areas correspond to higher and lower heights, respectively. In FIG. 17, the extensive bright areas of pristine MIC AFM image correspond to the nanofibrillar “bundle” phase in the width of 20-40 nm of interconnected fibrillar network with low surface roughness (R_{q}=3.01 nm, root-mean-square roughness). The dark area in the AFM image of pristine MIC corresponds to IL-rich liquid phase (FIG. 17). In FIG. 18, the electrochemically cycled cathode facing MIC surface exhibits the obvious raised regions (bright area) and sunken regions (dark area) with high surface roughness (R_{q}=8.81 nm) and the segregation of bundle phase in the width of 80-100 nm. In FIG. 18, the anode-facing side of the MIC showed significant surface roughness (R_{q}=13.6 nm) and deformation, as indicated from large sunken regions, which are ascribed to volumetric change during lithium stripping and plating at the interface. Additionally, dead lithium is observed at the surface of the anode-facing MIC, signifying that nonuniform ionic flux at the interface due to concentration heterogeneity may contribute to the formation of dead lithium (FIG. 17). FIG. 20 shows the height profile of three samples with 2 μm length, revealing the extensive development of surface roughness after electrochemical cycling. The electrochemically induced phase evolution of the MICs electrolyte results in the loss of conductive phase at the interface and decline of surface modulus up to a factor of 2 (FIG. 21). The AFM study provides insights into the electrochemically induced phase evolution of MIC, which supports the concentration heterogeneity observed in XRF maps, thereby leading to the detachment of the conductive phase at the electrode/electrolyte interfaces.

The ion transport behavior of MIC electrolyte is explored by pulsed-field-gradient (PFG) NMR diffusometry from 25 to 80° C., measuring the self-diffusion coefficients for the IL cations (¹H NMR) and IL anions (¹⁹F NMR). FIG. 22 shows cation diffusion coefficients (D⁺) and the anion diffusion coefficients (D⁻) of pristine and cycled MIC under varied temperatures, and averaged over the entire electrolyte thickness. In both the pristine MIC and cycled MIC, a faster diffusion of cations than anions is observed throughout the temperature range. The cycled MIC shows 22% decreased D⁺ and D⁻ compared to pristine MICs, suggesting that ion transport properties averaged over the whole MIC sample have changed after electrochemical cycling. The total ionic diffusivity (D, the summation of the cation and anion diffusion coefficients) of pristine MIC and cycled MIC are 4.8±0.2×10⁻¹¹ and 3.7±0.2×10⁻¹¹ m²/s, respectively at 60° C., which is a 23% decrease due to cycling. From the XRF imaging, we can infer that the decrease in diffusivities will be far larger near the electrode interfaces than this modest 23% decrease implies. These diffusion coefficient results indicate that interfacial concentration and chemical heterogeneity affect bulk ion transport properties, eventually contributing to SSBs failure. The worsened transport properties originate from the regions close to the interfaces. When the electrolyte becomes very thin and the interfacial region represents a significant fraction of the electrolyte, the interfacial heterogeneity may completely shut down the ion transport between the cathode and anode in a battery cell.

### The Role of Additive in Mitigating Concentration and Chemical Heterogeneities

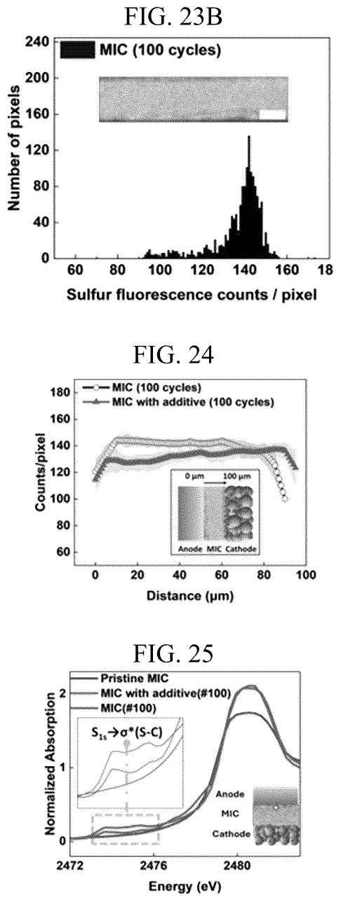

Based on the discovery that the concentration and chemical heterogeneities drive the degradation of MIC electrolyte, the role of additive was investigated using synchrotron X-ray analysis. MIC and MIC with additive after 100 cycles are prepared to evaluate the extent of concentration and chemical heterogeneities. To evaluate the influence of additive on ionic concentration profile, the comparable size of the cross-sectional sample is selected: MIC (400×95 μm²) and MIC with additive (400×100 μm²). The MIC presented a higher degree of concentration heterogeneity compared to the MIC with additive (FIGS. 23A and 23B), showing an elongated tail in the histogram. In FIG. 24, the line profile analysis shows the sulfur fluorescence signal with respect to distance from interfaces of MIC and MIC with additive. The MIC and MIC with additive show relatively homogeneous ion concentration distribution within the bulk region (20-80 μm). However, MIC displays an abrupt decline of sulfur counts per pixel at interfaces: a 16.4% decrease at the anode-electrolyte interface (0-10 μm) and a 25.9% decrease at the cathode-electrolyte interface (78-90 μm). On the other hand, MIC with additive shows a lower degree of sulfur fluorescence signal decline at interfaces: an 11% decrease at the anode-electrolyte interface (0-10 μm) and a 9.8% decrease at the cathode-electrolyte interface (78-90 μm). The lower degree of concentration depletion at the cathode-electrolyte interface aligns with the beneficial effect of LiDFOB on stabilizing the cathode-electrolyte interface. Therefore, considering the lower standard deviation from sulfur fluorescence counts per pixel histogram of MIC with additive (FIGS. 23A and 23B) and its mitigated concentration decline at interfaces (FIG. 24), the additive has proven effective in ameliorating concentration heterogeneity.

FIG. 25 shows XAS analysis to interrogate chemical species evolved from interfacial side reactions. MIC with additive display suppressed the chemical heterogeneity at the anode-electrolyte interface compared to baseline MIC due to the passivation layer created by LiDFOB decomposition, mitigating the reductive decomposition of polymer electrolyte (FIG. 25).

The present inventors also investigated the design of MICs including sulfolane to enhance transport and act as a functional salt additive to improve interfacial stability. Sulfolane (SL) is a small molecule solvent with high oxidation stability (5.5V vs. Li/Li⁺), non-flammability, and a high dielectric constant (43.4). Moreover, SL has a high boiling point (285° C.) and lower viscosity than ILs, making it a suitable candidate for MIC components by forming a free-standing solid electrolyte membrane without solvent leakage and decreased viscosity. Also, the high dielectric constant of SL effectively dissolves lithium salts, which is conducive to incorporating functional additive salts into the MICs. The “designed MIC” prepared herein including SL demonstrates good cycling performance in Li//LiNi_{0.8}Co_{0.1}Mn_{0.1}O₂(NMC811) cells, providing avenues for tailoring PEs to enable high-voltage lithium batteries.

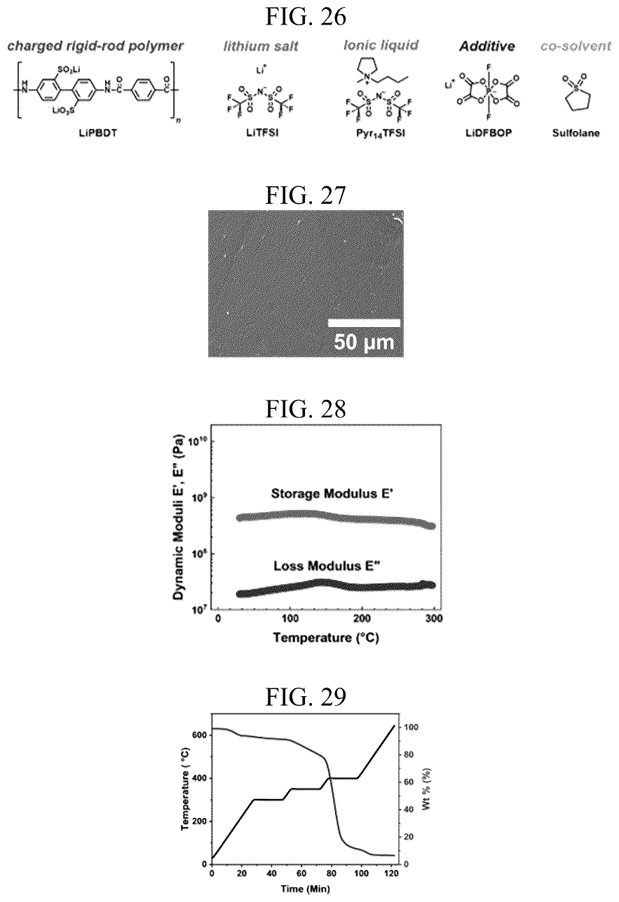

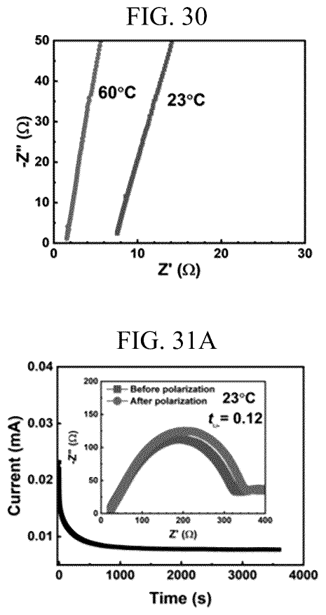

The designed MIC electrolyte membrane studied here included 7.5 wt % PBDT polymer with 7.5 wt % lithium bis(trifluoromethyl sulfonyl)imide (LiTFSI), 60 wt % 1-butyl-1-methylpyrrolidinium bis(trifluoromethyl sulfonyl)imide (Pyr₁₄TFSI), 22.5 wt % of sulfolane (SL), and 2.5 wt % of lithium difluorobis(oxalate) phosphate (LiDFBOP) as shown in (FIG. 26). The free-standing designed MIC membrane was prepared from solvent casting. The SEM image shows the homogeneous surface of the as-prepared membrane without any salt agglomeration (FIG. 27). The DMTA analysis in FIG. 28 displays the storage tensile modulus (E′) of 400 megapascals (MPa) and a loss modulus (Σ″) of 20-30 MPa over a wide temperature range (up to 300° C.). This MIC membrane maintains robust mechanical properties with thermal stability (FIG. 28). FIG. 30 shows a TGA analysis of the designed MIC membrane over the temperature range of 25° C. to 650° C. to understand thermal degradation with the ramp rate of 10° C./min with 20-minute isotherms at 300, 350, and 400° C. FIG. 29 displays the thermal degradation of the membrane at 400° C. as evidenced by the 90% reduction in mass and the 5% decrease in mass at 150° C., which is attributed to the thermal decomposition of LiDFBOP.

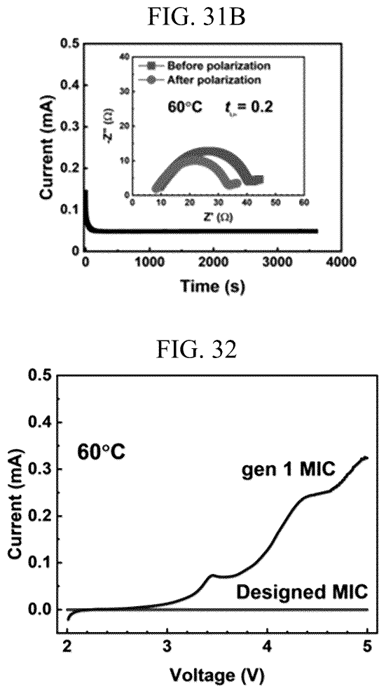

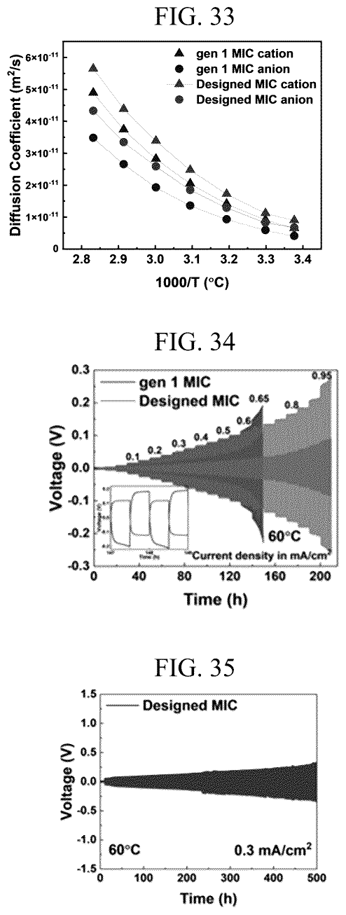

The ionic conductivity of the designed MIC electrolyte is 0.66 mS cm⁻¹ at 23° C. and 3.21 mS cm⁻¹ at 60° C. (FIG. 30). The transference number of the designed MIC electrolyte is 0.12 at 23° C. and 0.2 at 60° C. (FIGS. 31A and 31B). FIG. 32 shows the linear voltammetry sweep (LSV) results of MIC and the designed MIC at 60° C. The oxidative current peak appears at ˜3.4 V vs. Li/Li⁺ with a recorded current of 0.1 mA for MIC, which is attributed to the oxidative decomposition of the PBDT polymer. Meanwhile, the designed MIC shows improved stability against oxidative decomposition, ascribed to the passivation layer from sulfolane and LiDFBOP. The self-diffusion coefficients of IL are measured by pulsed-field-gradient (PFG) NMR diffusometry to explore the ion transport behavior of MIC and the designed MIC. FIG. 33 shows cation diffusion coefficients (D⁺) and the anion diffusion coefficients (D⁻) from IL cations (¹H NMR) and IL anions (¹⁹F NMR) from 23 to 80° C., which is averaged over the entire electrolyte thickness. A faster diffusion of cations than anions is observed throughout the temperature range in both the gen 1 MIC and the designed MIC. The total ionic diffusivity (D, the summation of the cation and anion diffusion coefficients) of the gen 1 MIC and the designed MIC are 2.59×10⁻¹¹ and 3.39×10⁻¹¹ m²/s, respectively, at 60° C., which is 26% higher for the designed MIC. Overall, the designed MIC shows improved oxidation stability and a higher diffusion coefficient than the gen 1 MIC from the compositional tailoring.

Li symmetric cells were cycled to evaluate electrolyte compatibility with Li metal anode at 60° C. as a function of (stepped) current density (FIG. 34). The gen 1 MIC limiting current density was 0.65 mA cm⁻², and the designed MIC was 0.95 mA cm⁻². The designed MIC's lower overpotential and higher limiting current density indicate improved lithium plating and stripping. The inset of FIG. 34 shows the overpotential of the gen 1 MIC and the designed MIC to be 184 mV and 121 mV, respectively. FIG. 35 shows a Li symmetric cell with a constant current density at 60° C. for 500 h, demonstrating the long-term cycling stability of the designed MIC, although there is increasing overpotential upon extensive cycling.

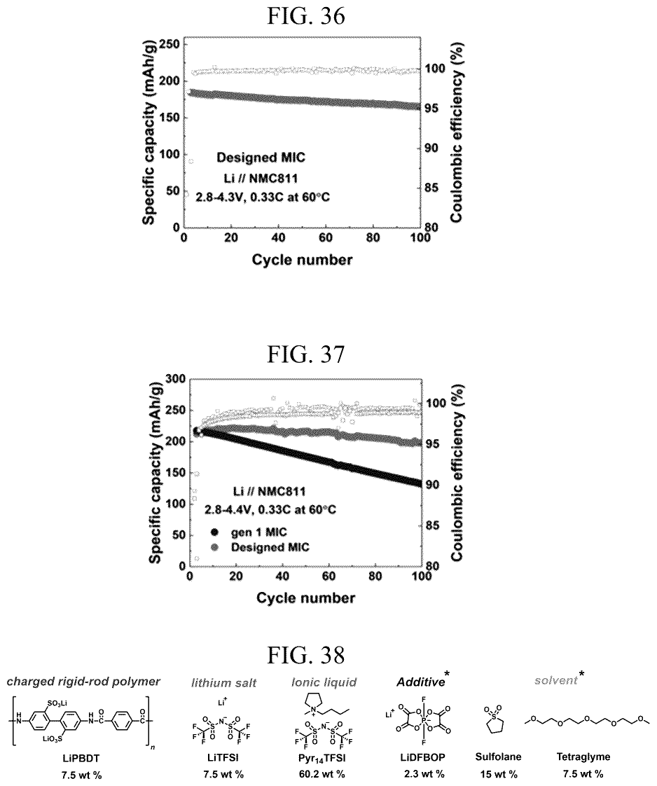

To assess the electrochemical performance of the designed MIC electrolyte in high-voltage Li metal batteries, Li|MIC|LiNi_{0.8}Co_{0.1}Mn_{0.1}O₂(NMC811) full cells were assembled and cycled at 60° C. with different upper cutoff voltages of 4.3V and 4.4V. FIG. 36 shows a designed MIC-based full cell with a cutoff voltage of 4.3V at 60° C. for 100 cycles. The capacity retention after 100 cycles for designed MICs is over 89%, with a high initial discharge specific capacity of 184 mAh g⁻¹ at C/3 (FIG. 36), demonstrating good cycling stability. FIG. 37 shows the cycling performance of the gen 1 MIC and the designed MIC full cells with a cutoff voltage of 4.4V at 60° C. The designed MIC delivers a high discharge specific capacity of 212 mAh g⁻¹ at C/3 and capacity retention of 93% after 100 cycles. Meanwhile, gen 1 MIC showed capacity retention of 61% after 100 cycles, indicating outstanding cycling performance of the designed MIC.

Scanning electron microscopy (SEM) image of the cycled lithium metal anode and NMC811 cathode, interfaced with the designed MIC, after 100 cycles with an upper-cut-off voltage of 4.4V at 60° C. revealed uniform plating of Li on the Li anode surface, which aligns with the efficient plating/stripping voltage profile. The results indicate that the designed MIC has improved lithium plating/stripping and good dendrite suppression. The surface of the cycled NMC811 cathode shows uniform coverage of the designed MIC over active material, suggesting intimate contact between the designed MIC and electrode. The Nyquist plot of the designed MIC showed a stable resistance profile up to 100^{th} cycles. The decrease in the interfacial resistance after the 100^{th} cycle suggests an intimate contact and stable passivation layer is formed between electrodes and electrolytes, which aligns with full-cell cycling results.

In summary, the present inventors have demonstrated the tailoring of MIC electrolytes and achieved high-performance SSBs. The judicious selection of electrolyte components offered PEs with high oxidation stability and good cycling performance in high-voltage, solid-state lithium batteries. Experimental details follow.

Molecular ionic composite (MIC) membrane preparation. The gen 1 MIC electrolyte is prepared as previously reported. Meanwhile, the designed MIC electrolyte is prepared by dissolving 120 mg of LiPBDT in 12 g of H₂O. 120 mg of LiTFSI, 360 mg of sulfolane, 36 mg of LiDFBOP and 960 mg of Pyr₁₄TFSI are dissolved in 12 g of DMF. After heating the two separate solutions to 80° C. inside the oven overnight, they were mixed and equilibrated at 80° C. overnight. The mixed solution is cast on a 10×10 cm² glass plate and dried overnight at 80° C. in the oven, to evaporate the solvents. The designed MIC membrane is further dried at 100° C. in a vacuum oven for 2 days. The designed MIC membrane is peeled off the glass substrate and punched into 19 millimeter (mm) disks with ≈100 μm thickness.

Cell assembly and testing. The electrode is prepared using 92% active material, 4% polyvinylidene fluoride, and 4% acetylene carbon black in N-methyl-2-pyrrolidone and cast onto carbon-coated aluminum foil current collector. The prepared electrode is punched into φ10 mm disks and dried overnight in a vacuum oven at 120° C. The mass loading of the electrode is 3.0-4.0 mg cm⁻². The Li|MIC|NMC811 cells and lithium symmetric cells were assembled in an argon-filled glove box. Electrochemical testing was performed using a Neware battery testing system inside a temperature-controlled chamber. The critical current density of lithium symmetric cell is quantified by incremental current density steps at 60° C. Li|MIC|NMC811 cells were cycled between 2.8-4.3V or 2.8-4.4V at 60° C.

Measurement of transference number (t₊). Potentiostatic polarization method is conducted using BioLogic SP-200 instrument with a lithium symmetric coin cell under a constant direct current (DC) voltage bias (ΔV=10 mV) at 23° C. The EIS measurements are performed before and after the polarization in the frequency range of 5 MHz to 1×10⁻¹ Hz at 23° C. The lithium-ion transference number was calculated using the following equation⁵:

$${t}_{+} = \frac{{I}_{SS} ( ΔV - {I}_{0} {R}_{0} )}{{I}_{0} ( ΔV - {I}_{SS} {R}_{SS} )}$$

where I₀ is the initial state current and Iₛₛ is steady-state current after 1 h. The R₀ refers to the initial cell impedance and Rₛₛ is the steady-state cell impedance measured by EIS.

Ionic conductivity measurement. Stainless steel (SS) symmetric cells are assembled, sandwiching the molecular ionic composite (MIC) membrane with a thickness of 100 μm. The diameter of SS is 16 mm. The cells are rested overnight at 60° C. EIS is recorded for the cell with one repetition. Here the frequency range is 1 Hz to 1 MHz. The ionic conductivity is calculated using the following equation:

$$σ = \frac{d}{{R}_{b} \times S}$$

where d is the thickness of MIC membrane, R_{b} is the bulk resistance derived from Nyquist plots. S is the surface area of the SS.

Linear sweep voltammetry (LSV) measurement. The LSV is conducted to evaluate the electrochemical stability window of the designed MIC membrane using Biologic (SP150). It is measured at 60° C. in a temperature-controlled chamber, using aluminum foil as the working electrode and lithium metal as the counter and reference electrode, with a scan rate of 0.1 mV s⁻¹.

The Li anode and NMC cathode surface from cycled Li/MIC/NMC samples are characterized using a scanning electron microscope (SEM, JEOL IT500). The thermo-mechanical properties of the designed MIC are measured by dynamic mechanical thermal analysis (DMTA). Thermogravimetric (TGA) analysis is conducted to evaluate the thermal stability of the designed MIC membrane. The nuclear magnetic resonance (NMR) diffusometry measurements are performed to measure the diffusion coefficient of electrolyte membranes with temperature variation.

Dynamic mechanical thermal analysis (DMTA). The DMTA was performed with a thermal analysis instrument (DMA850) equipped with a rectangular film clamp to measure the storage (E′) and loss (E″) moduli of our samples. The ramp rate of 2° C./min from 30 to 300° C. with a constant oscillation amplitude of 15 μm at a frequency of 1 Hz is used in measurement. The designed MIC maintains a stable storage modulus at 400 MPa, consistent with the tensile storage modulus of the MIC membrane with 10 wt % PBDT found in the literature.

Thermalgravimetric analysis (TGA). The TGA was performed with a TA Instruments TGA550 utilizing Pt pans at a 10° C. min⁻¹ rate in a dry N₂ atmosphere. The first experiment was a constant temperature ramp from 30° C. to 650° C. The degradation of the designed MIC occurred at 400° C., which is consistent with previous literature³. The 5% decrease in mass seen at 150° C. is ascribed to the decomposition of LiDFBOP.

NMR diffusometry measurements. The MIC films were inserted into 5 mm diameter NMR sample tubes and dried at 100° C. under vacuum in a hot sand bath. The tubes were flame-sealed under vacuum before measuring diffusion. The NMR spectra and diffusion data were obtained using a Bruker Avance III 400 MHz/9.4 T wide-bore spectrometer equipped with a high gradient diffusion probe (Bruker Diff50) paired with a 5 mm ¹H RF coil insert.

The NMR diffusometry experiments were performed over the temperature range of 25 to 80° C. with >5 min of thermal equilibration before acquiring data at each temperature. The pulsed-gradient stimulated echo (PGSTE) experiment was run on ¹H and ¹⁹F nuclei to obtain the self-diffusion coefficients of the cation and anion, respectively. The Stejskal-Tanner equation was used to fit the measured signal amplitude (I) as a function of gradient strength (g):

$$I = {I}_{0} exp ( - D {γ}^{2} {g}^{2} {δ}^{2} ( Δ - \frac{δ}{3} ) )$$

Where I₀ is the signal amplitude at g=0, γ is the gyromagnetic ratio of the measured nucleus, δ is the effective (rectangular) gradient pulse duration, Δ is the diffusion time between gradient pulses, and D is the self-diffusion coefficient. The measurements used a 90° pulse time of 3.7 ρs for ¹H and 6 ρs for ¹⁹F, and an acquisition time of 0.02 s for both nuclei. The diffusion experiments used repetition times of 1-2 s, δ=1 ms, Δ=50 ms, and max gradient strength ranging from 600-1500 G/cm to achieve ≥85% signal attenuation in 16 steps.

Building upon results already provided herein, the present inventors further discovered a composition incorporating additional functional additives and co-solvents to enhance interfacial stability and maintain ionic conformality, while remaining free from leakage and ensuring strong electrochemical performance. Termed “NG-2 MIC”, these compositions were found to effectively suppress depletion of the ion-conductive phase, reduce chemical heterogeneity, and improve the electrochemical performance of high-voltage lithium batteries.

NG-2 MIC used in the present examples included 7.5 wt % poly-2,2′-disulfonyl-4,4′-benzidine terephthalamide (PBDT), 7.5 wt % lithium bis(trifluoromethylsulfonyl)imide (LiTFSI), 60.2 wt % 1-butyl-1-methylpyrrolidinium bis(trifluoromethylsulfonyl)imide (Pyr₁₄TFSI), 15 wt % sulfolane (SL), 7.5 wt % tetraglyme (G4), and 2.3 wt % lithium difluorobis(oxalate)phosphate (LiDFBOP) (FIG. 38). This composition was specifically tailored to optimize ionic conductivity, mechanical properties, and compatibility with lithium metal and Ni-rich cathodes. NG-2 MIC forms a uniform, freestanding membrane suitable for direct integration into SSBs. The incorporation of SL and G4 enhances ionic transport without compromising mechanical integrity, while LiDFBOP contributes to the formation of a stable interphase on electrodes and mitigates parasitic side reactions.

The additives in NG-2 MIC each fulfill distinct functional roles. LiDFBOP decomposes during initial cycling to generate a lithium fluoride-rich interphase, effectively passivating lithium metal anode and high-voltage cathodes. Sulfolane, a high-permittivity solvent, promotes lithium-ion dissociation, enabling stable operation at elevated voltages and temperatures. Tetraglyme enhances lithium-ion transport by coordinating with lithium ions, reducing aggregation, and increasing ion mobility.

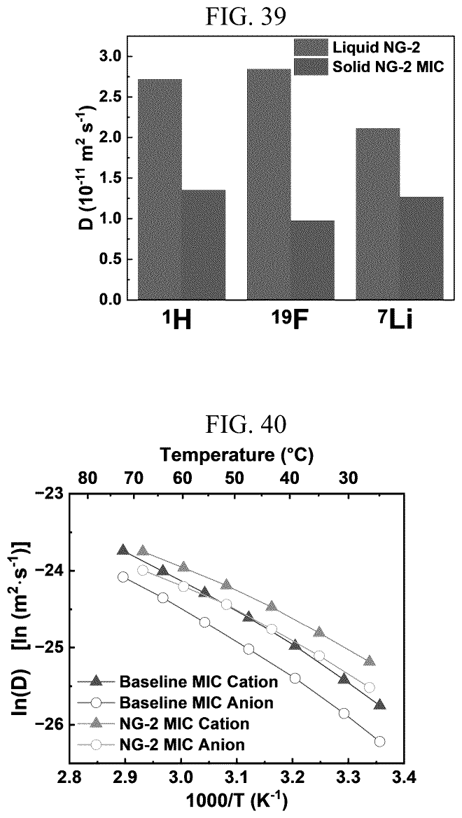

To investigate ion transport in NG-2 MIC, nuclear magnetic resonance (NMR) spectroscopy and diffusometry was utilized. The static solid-state spectra of the MIC film contains significantly larger linewidths than typical solution-state NMR spectra, resulting in all signals coalescing into one broad peak. As such, the proton diffusion coefficient of the solid MIC film is the average of all the proton containing species in the sample. This diffusion coefficient can be compared to the individual components of the MIC by preparing a sample without PBDT, resulting in a liquid sample with the same relative composition as the solid MIC. Furthermore, it was found that when comparing the diffusion coefficients between the solid MIC film and this solution of the MIC components, the diffusion coefficient is only 2-3 times faster in the liquid sample. The ⁷Li spectrum of both the solid MIC and the liquid sample of the MIC components showed the linewidth becomes 150 times broader in the solid sample. Measuring the diffusivity of the ⁷Li and ¹⁹F nuclei of the solid MIC and comparing it to the liquid sample also shows a factor of 2-3 times faster diffusion in the liquid sample (FIG. 39). FIG. 40 shows the temperature dependence of the diffusion coefficients of the IL cations (¹H NMR) and the fluorine-containing anions within the solid MIC film over a temperature range of 25 to 80° C. Using the Arrhenius equation, the activation energy of these ions can be extracted within the MIC films. The cation of the NG-2 MIC film has an activation energy (Eₐ) of 29.3 kJ/mol and the anion has an Eₐ of 31.2 kJ/mol. Compared to the Eₐ values of the baseline MIC, 36.2 kJ/mol and 38.5 kJ/mol for the cation and anion respectively, it was found that the NG-2 MIC has a 7 kJ/mol lower Eₐ for both ions. This enhanced transport property is expected to translate directly into improved electrochemical performance during battery cycling.

NG-2 MIC was fabricated into a translucent and flexible self-supporting membrane approximately 100 μm thick using a solvent casting method. Scanning electron microscopy (SEM) imaging confirmed a homogeneous surface, indicating uniform distribution of all electrolyte components.

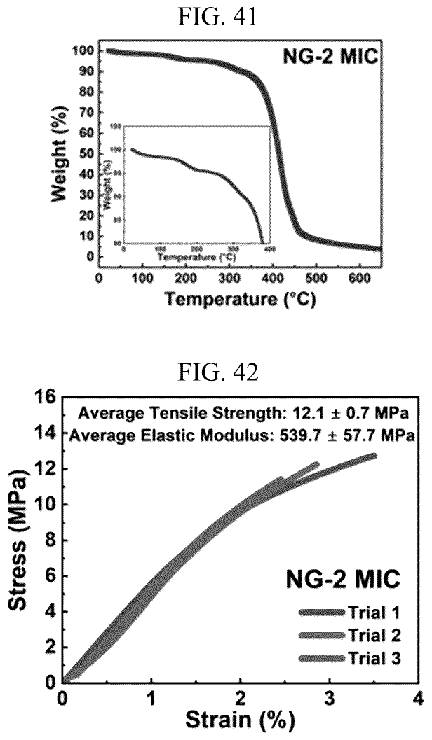

Thermogravimetric analysis (TGA) was performed under nitrogen at a heating rate of 10° C. min⁻¹ up to 650° C. to evaluate thermal stability (FIG. 41). The NG-2 MIC membrane exhibited minimal weight loss (˜5 wt %) up to 200° C., followed by an additional mass loss reaching ˜20 wt % at approximately 380° C., and significant decomposition above 400° C. To understand this behavior, TGA of individual membrane components was also conducted. The initial ˜5 wt % loss up to 200° C. is attributed primarily to the decomposition of LiDFBOP (onset ˜150° C.), G4 (onset ˜155° C.), and SL (onset ˜170° C.). Subsequently, the gradual mass loss observed up to 380° C. corresponds to the thermal degradation of the remaining NG-2 MIC components.

The uniaxial tensile stress-strain curve of the NG-2 MIC membrane is presented in FIG. 42, revealing an average tensile strength of 12 MPa and an elastic modulus of 540 MPa, determined from three independent measurements. Additionally, the thermomechanical properties were evaluated by dynamic mechanical thermal analysis (DMTA). Across the temperature range of 30° C. to 300° C., the NG-2 MIC exhibited a storage modulus (E′) of approximately 750 MPa and a loss modulus (E″) of around 40 MPa. Collectively, the results from tensile testing and DMTA confirm the excellent mechanical robustness of the NG-2 MIC membrane, highlighting its suitability for practical handling and integration into cell assembly.

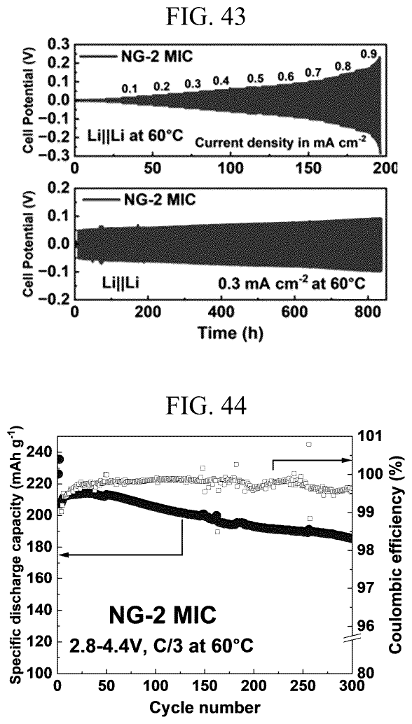

Electrochemical performance of the MIC electrolytes according to this aspect was evaluated in lithium metal cells. The Li∥Li symmetric cells were cycled at 60° C. under both stepped and constant current densities to assess the compatibility of NG-2 MIC membranes with Li metal electrodes (FIG. 43). The potential response revealed a limiting current density of 0.9 mA cm⁻² with NG-2 MIC, exhibiting an overpotential below 70 mV at 0.5 mA cm⁻². Long-term cycling at 0.3 mA cm⁻² demonstrated stability beyond 800 hours, maintaining an overpotential below 90 mV. These results confirm the strong compatibility of NG-2 MIC with Li metal electrodes. NG-2 MIC demonstrated ionic conductivities of 1.5 mS cm⁻¹ at 23° C. and 3 mS cm⁻¹ at 60° C., along with a moderate Li⁺ transference number (t_{Li+}=0.36), underscoring its potential as an electrolyte for SSBs.

Given its promising physicochemical properties, including moderate ionic conductivity, mechanical robustness, and thermal stability, Li∥NMC811 coin cells were assembled to evaluate electrochemical performance, with no additional liquid electrolyte. FIG. 44 presents the cycling stability of Li∥NMC811 cells at a cutoff voltage of 4.4 V at 60° C., tested for 300 cycles at C/3 following two pre-conditioning cycles at C/20 (1C=200 mA g⁴). The cell delivered an initial discharge capacity of 207 mAh g⁻¹ at C/3, retaining 185.5 mAh g⁻¹ after 300 cycles. The discharge capacity retention after 200 and 300 cycles was 93% and 89.5%, respectively, demonstrating stable cycling at an elevated temperature and high cutoff voltage.

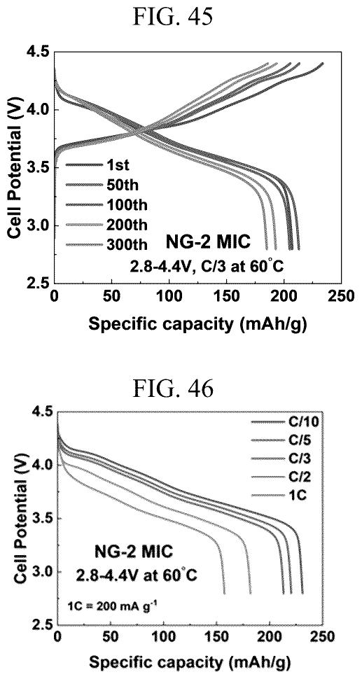

FIG. 45 shows the charge-discharge potential profiles of Li∥NMC811, illustrating minimal capacity fading. The initial specific discharge capacity of 207 mAh g⁻¹ at C/3 increased to 212 mAh g⁻¹ after 50 cycles, likely due to enhanced ion transport in the cathode. FIG. 46 presents the rate capability, where the Li∥NMC811 cell demonstrated good performance with specific discharge capacities of 226 mAh g⁻¹ at C/10, 197 mAh g⁻¹ at C/2, and 169 mAh g⁻¹ at 1C in the potential range of 2.8-4.4 V at 60° C.

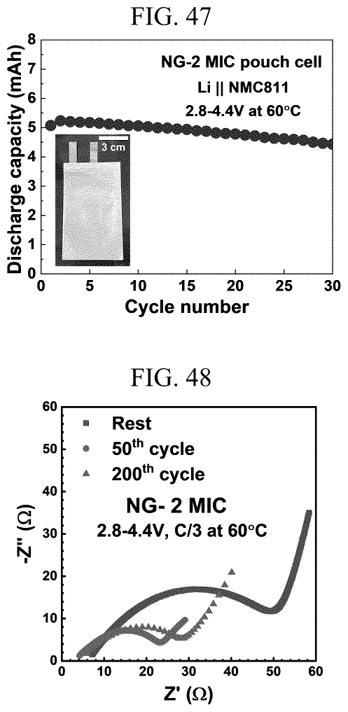

The electrochemical performance of a single-layer Li∥NMC811 pouch cell cycled between 2.8-4.4 V at C/3 (67 mA g⁻¹), 60° C. and ˜1 MPa stack pressure is shown in FIG. 47. The cell consisted of an NMC811 cathode (areal capacity of ˜0.6 mAh cm⁻²), a 50 m-thick lithium metal anode, and a ˜100 μm thick NG-2 MIC membrane. The pouch cell delivered an initial specific discharge capacity of 224 mAh g⁻¹ (based on cathode active material), corresponding to a discharge capacity of 5.2 mAh, and exhibited stable cycling performance. Additionally, the Nyquist plots for the Li∥NMC811 coin cell (FIG. 48) reveal only minimal impedance increase over cycling, suggesting the formation of stable electrodelelectrolyte interfaces.

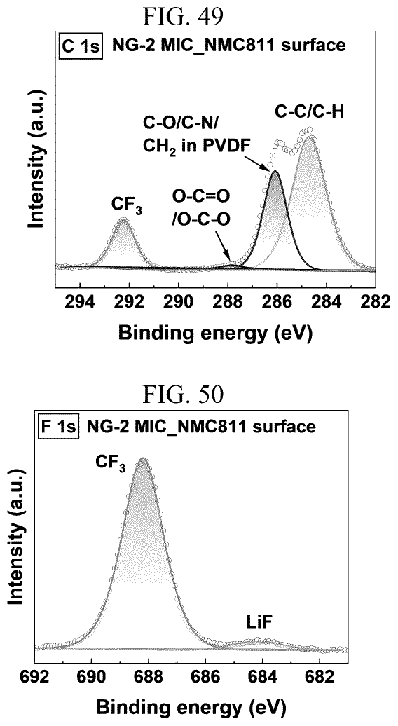

Electrochemical testing confirmed enhanced cycling stability in NG-2 MIC-based cells. To elucidate the underlying mechanism, we conducted X-ray photoelectron spectroscopy (XPS) and time-of-flight secondary-ion mass spectrometry (TOF-SIMS) analyses to characterize the passivation layer formed at electrode-electrolyte interfaces. FIG. 49 presents XPS spectra and TOF-SIMS analysis of the cycled NMC811 cathode harvested from a Li∥NMC811 coin cell (cycled at 2.8-4.4 V, C/3, 200 cycles, 60° C.).

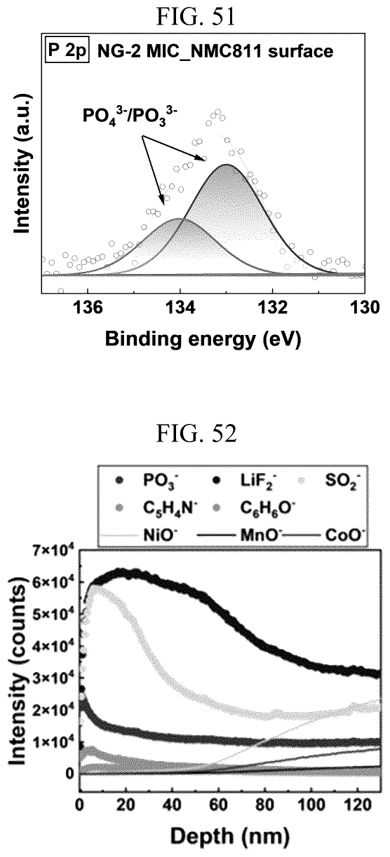

The atomic composition of the cycled NMC811 surface revealed a fluorine-rich interphase comprising C (43.2%), 0 (16.7%), F (25%), N (7.5%), S (7.4%), and P (0.2%). The C is spectra (FIG. 49) exhibit multiple peaks indicative of diverse organic species: CF₃ (˜292.18 eV, originating from PVDF binder), O—C═O and O—C—O (˜287.88 eV, organic carbonates and oxalates derived from LiDFBOP and G4 decomposition), C—O (˜286.1 eV), C—N (˜286 eV), CH₂ (˜286.2 eV, polymeric and organic species), and C—C/C—H (˜285 eV, hydrocarbons). These assignments align with previously reported SEI formation mechanisms in lithium-ion batteries. The F is spectra (FIG. 50) show peaks at 688 eV (CF₃) and 684 eV (LiF). The P 2p spectra (FIG. 51) exhibit peaks at 133-134 eV corresponding to phosphate (PO₄³⁻) and phosphite (PO₃³⁻) species, arising from LiDFBOP decomposition.

Additionally, the N is spectra display peaks at 402 eV (N⁺) and 398.7 eV (N⁻), attributed respectively to the pyrrolidinium cation (Pyr₁₄⁺) and (trifluoromethanesulfonyl)imide anion (TFSI⁻). The O 1s spectra feature a peak at ˜532 eV (O—C═O, ROCO₂Li), derived from LiDFBOP and G4 decomposition products, confirming electrolyte additive-driven surface passivation. The S 2p spectra exhibit peaks around 168-169 eV, indicative of sulfonate species (−SO₂CF₃) from TFSI decomposition. SOₓ species (˜167-169 eV) further confirm SL decomposition contributing to interphase formation.

High-resolution 3D chemical analysis via TOF-SIMS further elucidated spatially resolved interphase chemistry. Relative quantification of interphase species was performed using secondary ion intensities. High-resolution TOF-SIMS depth profiling from the cathode surface 0 nanometers (nm) to 130 nm (cycled at 2.8-4.4 V, C/3, 200 cycles, 60° C.) revealed inorganic decomposition products (PO₃⁻, LiF₂⁻), organic decomposition products (SO₂⁻, C₅H₄N⁻, C₆H₆O⁻), and transition metal oxides (NiO⁻, MnO⁻, CoO⁻). Among these, LiF₂⁻ displayed the highest intensity across the surveyed depth, indicating a predominantly inorganic-rich interphase. PO₃⁻ showed high surface intensity but remained present throughout the interphase depth (FIG. 52). Organic SO₂⁻ was abundant near the surface, decreasing gradually but remaining dominant among organics. In contrast, C₅H₄N⁻ and C₆H₆O⁻ exhibited consistently low intensities.

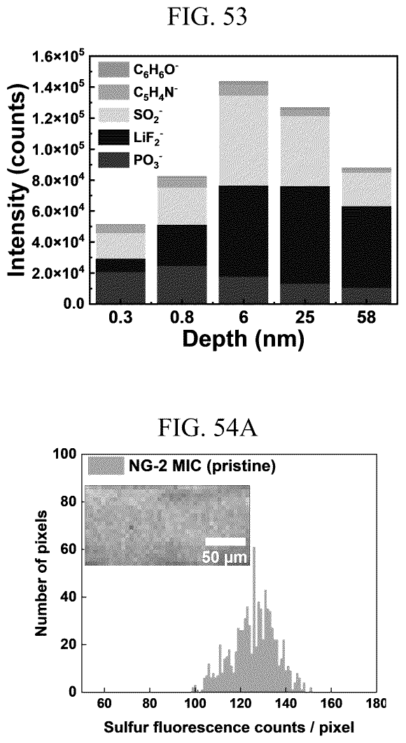

The intensity distribution of species at selected depths (FIG. 53) indicated surface enrichment at 0.3 nm, with PO₃⁻ (40.1%) and SO₂⁻ (31.9%) as dominant species, suggesting phosphorus- and sulfur-rich interphase stabilization. LiF₂⁻ increased significantly at greater depths (>40%), reinforcing the formation of a robust inorganic-rich interphase.

In summary, the combined XPS and TOF-SIMS analyses reveal that NG-2 MIC forms a passivation layer at the NMC811 cathode interface. LiDFBOP decomposition produces stable inorganic species (LiF, phosphates), while SL and G4 contribute critical organosulfur and organic carbonate species, respectively. These interphase components significantly stabilize the electrodelelectrolyte interface at high voltages (4.4 V) and elevated temperatures (60° C.), directly resulting in the enhanced cycling stability observed in NG-2 MIC-based lithium metal batteries.

XRF microscopy measurements enabled sulfur elemental mapping across cross-sections of MIC electrolytes, providing direct visualization of sulfur species distribution at electrode-electrolyte interfaces. In baseline MIC, the sulfur fluorescence originates primarily from the sulfonate (—SO₃) groups of the rigid-rod ionic polymer and the sulfone (—SO₂) groups within the TFSI⁻ anion. In contrast, the sulfur fluorescence signals in NG-2 MIC electrolyte additionally arise from SL, alongside the previously mentioned components. Given the macromolecular nature of the rigid-rod ionic polymer and its relatively low weight percentage (7.5 wt %) in the NG-2 MIC electrolyte, changes in detected sulfur fluorescence intensity predominantly reflect the redistribution of sulfur-containing small molecules (82.7 wt %), specifically the TFSI anion (from the ionic liquid and LiTFSI, 67.7%) and SL (15%). Thus, XRF mapping effectively visualizes mobile ion concentrations within NG-2 MIC electrolytes.

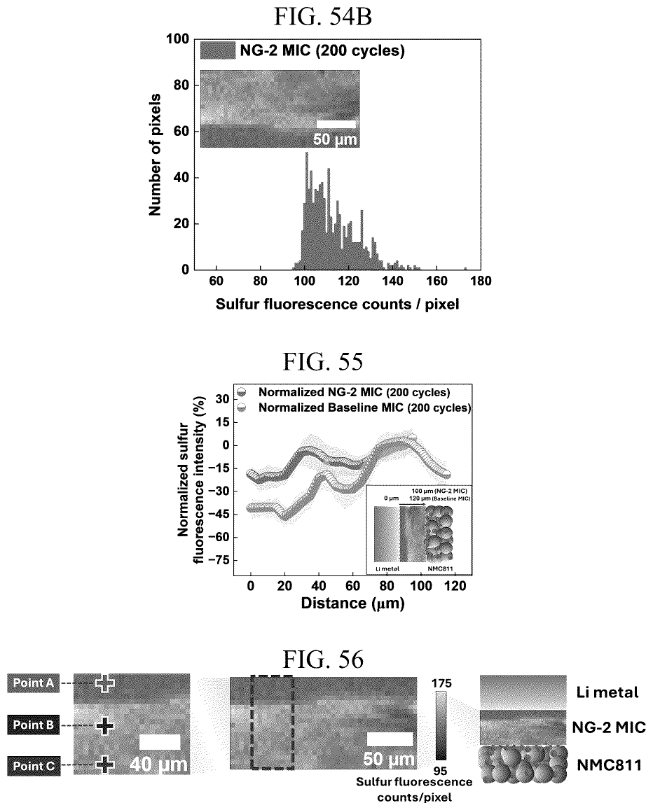

FIGS. 54A and 54B present sulfur XRF images of cross-sectioned NG-2 MIC electrolyte samples examined ex situ after testing in Li∥NMC811 cells under various electrochemical conditions. To evaluate the ionic concentration distribution, sulfur fluorescence counts per pixel (X-axis) are plotted against the number of pixels (Y-axis), providing insight into concentration heterogeneity. Representative regions of comparable cross-sectional areas were selected to ensure a valid comparison.

In the pristine NG-2 MIC electrolyte, the histogram exhibits a uniform, Gaussian-like distribution in sulfur fluorescence counts per pixel (FIG. 54A), indicating a homogeneous ionic distribution. The XRF image of an NG-2 MIC electrolyte membrane harvested from an assembled coin cell, rested at 60° C. and open circuit potential (OCP) for 1 day. The pressure applied during cell assembly (0.2 MPa) was observed to not significantly alter the mobile ion concentration at the electrodelelectrolyte interface, consistent with prior observations for original MIC. After 200 charge and discharge cycles (2.8-4.4 V, C/3, 60° C.) in Li∥NMC811 cells (FIG. 54B), the sulfur fluorescence intensity histogram of NG-2 MIC (200 cycles) broadens and shifts toward lower intensity values, indicating an increase in concentration heterogeneity due to the redistribution of mobile ions.

The line profile analysis provides a detailed view of sulfur fluorescence intensity variations as a function of distance across the electrodelelectrolyte interfaces, offering quantitative insights into ion redistribution during cycling (FIG. 55). As shown in FIG. 55, the normalized sulfur fluorescence intensity profiles for NG-2 MIC (200 cycles) and baseline MIC (200 cycles) reveal distinct differences in how ion concentration evolves over extended cycling. The normalized sulfur fluorescence intensity (%) vs. distance (μm) is determined by calculating the relative change in sulfur fluorescence intensity compared to the pristine electrolyte composition. A decrease in normalized sulfur fluorescence intensity (%) for the cycled ex situ sample indicates a lower intensity relative to the pristine sample, reflecting ion redistribution or depletion.

For baseline MIC (200 cycles) in FIG. 55, the sulfur fluorescence intensity exhibits a steep decline of ˜40% at the negative electrodelelectrolyte interface (X=0-20 μm), indicating significant mobile ion depletion near the Li metal interface. The bulk region (X=20-100 μm) displays a high degree of heterogeneity, with fluctuations ranging from −45% to +2%, highlighting the extent of concentration variations across the electrolyte membrane. Furthermore, the positive electrodelelectrolyte interface (X=100-120 μm) shows a sharp decline in sulfur fluorescence intensity, signaling a severe breakdown of the two-phase electrolyte structure, likely due to progressive side reactions near the cathode.

In contrast, NG-2 MIC (200 cycles) in FIG. 55 maintains a more uniform fluorescence intensity profile. At the negative electrodelelectrolyte interface (X=0-20 μm), sulfur fluorescence intensity exhibits a modest decline of ˜20%, indicating less severe mobile ion depletion compared to baseline MIC. The bulk region (X=20-80 μm) experiences only a minor decrease (˜10%), demonstrating that while some concentration variation occurs, it is significantly less pronounced than in baseline MIC. Near the positive electrodelelectrolyte interface (X=80-100 μm), the intensity decrease remains below 5%, suggesting that NG-2 MIC effectively suppresses concentration heterogeneity at the cathode interface.

The more significant intensity variations in baseline MIC compared to NG-2 MIC strongly support the conclusion that NG-2 MIC's tailored composition effectively reduces phase separation and ionic depletion at electrode-electrolyte interfaces, ultimately enhancing electrochemical stability and long-term performance. The more pronounced heterogeneity in baseline MIC is likely driven by the decomposition of the rigid-rod ionic PBDT polymer, particularly at the negative electrode interface, leading to electrolyte degradation and increased ionic transport resistance. NG-2 MIC significantly outperforms baseline MIC in maintaining ionic distribution uniformity, demonstrating a more uniform ionic concentration distribution after 200 cycles.

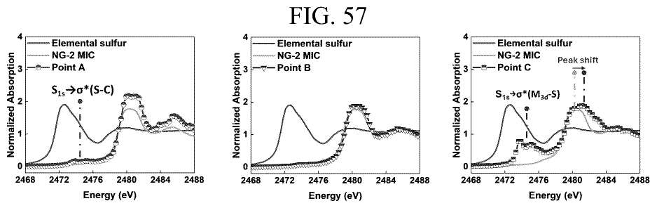

To investigate NG-2 MIC's chemical evolution, we performed XAS point scanning on cross-sectioned samples after 200 cycles (C/3, 60° C., 2.8-4.4 V). As illustrated in FIG. 56, XRF imaging identified key analysis points corresponding to distinct regions within the electrolyte: Point A (electrolyte|Li metal interface), Point B (bulk NG-2 MIC electrolyte), and Point C (electrolyte|NMC811 interface). The corresponding X-ray Absorption Near Edge Structure (XANES) spectra are shown in FIG. 57.

At Point A, a distinct low-energy feature at 2473.9 eV corresponds to the S₁ₛ→σ*(S-C) transition, indicative of low-valent sulfur species, likely sulfides. This observation suggests the occurrence of reductive decomposition of NG-2 MIC at the Li metal interface. At Point C (electrolyte|NMC811 interface), a feature at 2482.0 eV corresponds to S⁶⁺ as sulfate (SO₄²⁻), attributed to oxidative decomposition product. Additionally, a peak at 2473.6 eV, attributed to S₁ₛ→σ*(M_{3d}-S), suggests transition metal-chelated sulfonate species derived from the PBDT polymer.

Although relatively low intensities of these XANES decomposition-related features were observed for NG-2 MIC, we emphasize that a direct correlation between XANES feature intensity and the degree of electrolyte decomposition or electrochemical performance cannot be confidently established. The XANES data are localized and thus do not uniformly represent the entire sample. Nevertheless, the characteristic sulfur XANES features related to decomposition contribute to chemical heterogeneity at electrode-electrolyte interfaces.

Overall, the combined XRF and XAS analyses suggest that NG-2 MIC may have reduced both concentration and chemical heterogeneities, which could potentially contribute to improved long-term cycling stability.

The present examples illustrate the role of compositional tuning in regulating interfacial chemomechanics, effectively suppressing concentration heterogeneities, minimizing electrolyte decomposition, and promoting favorable ion transport at electrode-electrolyte interfaces.

A significant improvement is therefore provided by the present disclosure.

This disclosure further encompasses the following aspects.

Aspect 1: A composite electrolyte comprising: a sulfonated polyaramid; an ionic liquid; a dopant comprising an alkali metal salt; and an alkali metal salt additive that is different from the dopant and comprises an alkali metal phosphate salt, an alkali metal fluorophosphate salt, an alkali metal borate salt, an alkali metal fluoroborate salt, or a combination thereof.

Aspect 2: The composite electrolyte of aspect 1, wherein the composite electrolyte is a solid at a temperature of 25 to 200° C.

Aspect 3: The composite electrolyte of aspect 1 or 2, comprising 1 to 25 weight percent of the sulfonated polyaramid; 20 to 95 weight percent of the ionic liquid; 1 to 25 weight percent of the dopant; and 0.1 to 10 weight percent of the alkali metal salt additive; wherein weight percent is based on the total weight of the composite electrolyte.

Aspect 4: The composite electrolyte of any of aspects 1 to 3, wherein the sulfonated polyaramid comprises poly(2,2′-disulfonyl-4,4′-benzidine terephthalamide) or a derivative thereof.

Aspect 5: The composite electrolyte of any of aspects 1 to 4, wherein the sulfonated polyaramid is an alkali metal salt thereof, wherein the alkali metal salt comprises sodium, lithium, potassium, cesium, or a combination thereof.

Aspect 6: The composite electrolyte of any of aspects 1 to 4, wherein the sulfonated polyaramid is a metal salt thereof comprising a divalent metal cation, preferably wherein the divalent metal cation comprises zinc, magnesium, calcium, barium, or a combination thereof.

Aspect 7: The composite electrolyte of any of aspects 1 to 6, wherein the ionic liquid comprises an anion component and a cation component; wherein the anion component comprises halide, sulfate, sulfonate, carbonate, bicarbonate, phosphate, nitrate, nitrate, acetate, PF₆, BF₄, triflate, nonaflate, bis(trifluoromethylsulfonyl)imide, bis(fluorosulfonyl)imide, trifluoroacetate, heptafluorobutanoate, haloaluminate, or triazolide; and the cation component comprises imidazolium, pyridinium, pyrrolidinium, phosphonium, ammonium, sulfonium, thiazolium, pyrazolium, piperidinium, triazolium, pyrazolium, oxazolium, guanadinium, dialkylmorpholinium, an alkylated derivative of any of the foregoing, or an alkali metal cation.

Aspect 8: The composite electrolyte of any of aspects 1 to 7, wherein the ionic liquid comprises 1-butyl-1-methylpyrrolidinium bis(trifluoromethyl sulfonyl)imide.

Aspect 9: The composite electrolyte of any of aspects 1 to 8, wherein the dopant comprises lithium bis(trifluoromethyl sulfonyl)imide.

Aspect 10: The composite electrolyte of any of aspects 1 to 9, wherein the alkali metal salt additive is a lithium salt additive and comprises lithium difluorobis(oxalato) phosphate, lithium difluorophosphate, lithium phosphate, lithium difluoro(oxalato)borate, lithium bis(oxalato)borate, lithium tetrafluoroborate, or a combination thereof.

Aspect 11: The composite electrolyte of any of aspects 1 to 10, wherein the alkali metal salt additive comprises lithium difluoro(oxalate)borate or lithium difluorobis(oxalate) phosphate.

Aspect 12: The composite electrolyte of any of aspects 1 to 11, further comprising a sulfur-containing polar aprotic solvent.

Aspect 13: The composite electrolyte of aspect 12, wherein the sulfur-containing polar aprotic solvent comprises sulfolane, (tetramethylene sulfone), ethyl methyl sulfone, dimethyl sulfone, 1,3-propane sultone, or a combination thereof.

Aspect 14: The composite electrolyte of aspect 12, comprising 5 to 50 weight percent of the sulfur-containing polar aprotic solvent, wherein weight percent is based on the total weight of the composite electrolyte.

Aspect 15: The composite electrolyte of any of aspects 1 to 14, further comprising an oligoether compound.

Aspect 16: The composite electrolyte of aspect 15, wherein the oligoether compound comprises tetraethylene glycol dimethyl ether, triethylene glycol dimethyl ether, diethylene glycol dimethyl ether, dimethoxy ethane, polyethylene glycol dimethyl ether, or a combination thereof.

Aspect 17: The composite electrolyte of aspect 15 or 16, comprising 1 to 20 weight percent of the oligoether compound, wherein weight percent is based on the total weight of the composite electrolyte.

Aspect 18: The composite electrolyte of aspect 1, comprising 5 to 15 weight percent of the sulfonated polyaramid; 70 to 90 weight percent of the ionic liquid; 5 to 15 weight percent of the dopant; and 1 to 8 weight percent of the alkali metal salt additive; wherein the sulfonated polyaramid comprises poly(2,2′-disulfonyl-4,4′-benzidine terephthalamide) or a derivative thereof, the ionic liquid comprises 1-butyl-1-methylpyrrolidinium bis(trifluoromethyl sulfonyl)imide; the dopant comprises lithium bis(trifluoromethyl sulfonyl)imide; and the alkali metal salt additive comprises lithium difluoro(oxalate)borate.

Aspect 19: The composite electrolyte of aspect 1, comprising 5 to 15 weight percent of the sulfonated polyaramid; 50 to 70 weight percent of the ionic liquid; 5 to 15 weight percent of the dopant; 1 to 5 weight percent of the alkali metal salt additive; and 15 to 30 weight percent of a sulfur-containing polar aprotic solvent; wherein the sulfonated polyaramid comprises poly(2,2′-disulfonyl-4,4′-benzidine terephthalamide) or a derivative thereof; the ionic liquid comprises 1-butyl-1-methylpyrrolidinium bis(trifluoromethyl sulfonyl)imide; the dopant comprises lithium bis(trifluoromethyl sulfonyl)imide; the alkali metal salt additive comprises lithium difluorobis(oxalate) phosphate; and the sulfur-containing polar aprotic solvent comprises sulfolane.

Aspect 20: The composite electrolyte of aspect 1, comprising 5 to 15 weight percent of the sulfonated polyaramid; 50 to 70 weight percent of the ionic liquid; 5 to 15 weight percent of the dopant; 1 to 5 weight percent of the alkali metal salt additive; 10 to 25 weight percent of a sulfur-containing polar aprotic solvent; and 1 to 15 weight percent of an oligoether compound; wherein the sulfonated polyaramid comprises poly(2,2′-disulfonyl-4,4′-benzidine terephthalamide) or a derivative thereof, the ionic liquid comprises 1-butyl-1-methylpyrrolidinium bis(trifluoromethyl sulfonyl)imide; the dopant comprises lithium bis(trifluoromethyl sulfonyl)imide; the alkali metal salt additive comprises lithium difluorobis(oxalate) phosphate; the sulfur-containing polar aprotic solvent comprises sulfolane; and the oligoether compound comprises tetraethylene glycol dimethyl ether.

Aspect 21: The composite electrolyte of any of aspects 1 to 20, wherein the composite electrolyte has one or more of an ionic conductivity of 1×10⁻⁶ to 1.5×10⁻² S/cm at 23° C.; a storage modulus of 100 to 1000 MPa at 23° C.; and a loss modulus of 10 to 100 MPa at 23° C.

Aspect 22: A method of making the composite electrolyte of any of aspects 1 to 21, the method comprising: casting an aqueous solution comprising the sulfonated polyaramid; the ionic liquid; the a dopant; and the alkali metal salt additive; to form a cast membrane; and drying the cast membrane to provide the composite electrolyte.

Aspect 23: A battery comprising the composite electrolyte of any of aspects 1 to 21.

Aspect 24: The battery of aspect 23, comprising: an anode; a cathode; and the composite electrolyte disposed between the anode and the cathode.

Aspect 25: The battery of aspect 24, wherein the anode is a lithium metal anode and the cathode is LiNi_{0.8}Mn_{0.1}Co_{0.1}O₂.

Aspect 26: The battery of any of aspects 23 to 25, wherein the battery has an initial discharge capacity of 150 to 250 mAh/g at a temperature of 60° C. and at C/3; or a discharge capacity retention of at least 80%, or at least 85%, or at least 90% measured over 100 cycles or over 500 cycles at a temperature of 60° C. and at C/3.

Aspect 27: The battery of any of aspects 23 to 26, wherein the battery is charged and discharged over a voltage range of 2.8 to 4.4 V or over a voltage range of 2.8 to 4.3 V.

Aspect 28: The battery of any of aspects 23 to 27, wherein the battery has a limiting current density of greater than 0.5 mA cm-2.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Of” means “and/of” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A composite electrolyte comprising:
a sulfonated polyaramid;
an ionic liquid;
a dopant comprising an alkali metal salt; and
an alkali metal salt additive that is different from the dopant and comprises an alkali metal phosphate salt, an alkali metal hexafluorophosphate salt, an alkali metal borate salt, an alkali metal tetrafluoroborate salt, or a combination thereof.

2. The composite electrolyte of claim 1, wherein the composite electrolyte is a solid at a temperature of 25 to 200° C.

3. The composite electrolyte of claim 1, comprising
1 to 25 weight percent of the sulfonated polyaramid;
20 to 95 weight percent of the ionic liquid;
1 to 25 weight percent of the dopant; and
0.1 to 10 weight percent of the alkali metal salt additive;
wherein weight percent is based on the total weight of the composite electrolyte.

4. The composite electrolyte of claim 1, wherein the sulfonated polyaramid comprises poly(2,2′-disulfonyl-4,4′-benzidine terephthalamide) or a derivative thereof.

5. The composite electrolyte of claim 1, wherein the sulfonated polyaramid is
an alkali metal salt thereof, wherein the alkali metal salt comprises sodium, lithium, potassium, cesium, or a combination thereof; or
a metal salt thereof comprising a divalent metal cation, preferably wherein the divalent metal cation comprises zinc, magnesium, calcium, barium, or a combination thereof.

6. The composite electrolyte of claim 1, wherein the ionic liquid comprises an anion component and a cation component;
wherein
the anion component comprises halide, sulfate, sulfonate, carbonate, bicarbonate, phosphate, nitrate, nitrate, acetate, PF₆, BF₄, triflate, nonaflate, bis(trifluoromethylsulfonyl)imide, bis(fluorosulfonyl)imide, trifluoroacetate, heptafluorobutanoate, haloaluminate, or triazolide; and
the cation component comprises imidazolium, pyridinium, pyrrolidinium, phosphonium, ammonium, sulfonium, thiazolium, pyrazolium, piperidinium, triazolium, pyrazolium, oxazolium, guanadinium, dialkylmorpholinium, an alkylated derivative of any of the foregoing, or an alkali metal cation.

7. The composite electrolyte of claim 1, wherein the ionic liquid comprises 1-butyl-1-methylpyrrolidinium bis(trifluoromethyl sulfonyl)imide.

8. The composite electrolyte of claim 1, wherein the dopant comprises lithium bis(trifluoromethyl sulfonyl)imide.

9. The composite electrolyte of claim 1, wherein the alkali metal salt additive is a lithium salt additive and comprises lithium difluorobis(oxalato) phosphate, lithium difluorophosphate, lithium phosphate, lithium difluoro(oxalato)borate, lithium bis(oxalato)borate, lithium tetrafluoroborate, or a combination thereof.

10. The composite electrolyte of claim 1, further comprising 5 to 50 weight percent of a sulfur-containing polar aprotic solvent comprising sulfolane, (tetramethylene sulfone), ethyl methyl sulfone, dimethyl sulfone, 1,3-propane sultone, or a combination thereof, wherein weight percent is based on the total weight of the composite electrolyte.

11. The composite electrolyte of claim 1, further comprising 1 to 20 weight percent of an oligoether compound comprising tetraethylene glycol dimethyl ether, triethylene glycol dimethyl ether, diethylene glycol dimethyl ether, dimethoxy ethane, polyethylene glycol dimethyl ether, or a combination thereof, wherein weight percent is based on the total weight of the composite electrolyte.

12. The composite electrolyte of claim 1, comprising
5 to 15 weight percent of the sulfonated polyaramid;
70 to 90 weight percent of the ionic liquid;
5 to 15 weight percent of the dopant; and
1 to 8 weight percent of the alkali metal salt additive;
wherein
the sulfonated polyaramid comprises poly(2,2′-disulfonyl-4,4′-benzidine terephthalamide) or a derivative thereof;
the ionic liquid comprises 1-butyl-1-methylpyrrolidinium bis(trifluoromethyl sulfonyl)imide;
the dopant comprises lithium bis(trifluoromethyl sulfonyl)imide; and
the alkali metal salt additive comprises lithium difluoro(oxalate)borate.

13. The composite electrolyte of claim 1, comprising
5 to 15 weight percent of the sulfonated polyaramid;
50 to 70 weight percent of the ionic liquid;
5 to 15 weight percent of the dopant;
1 to 5 weight percent of the alkali metal salt additive; and
15 to 30 weight percent of a sulfur-containing polar aprotic solvent;
wherein
the sulfonated polyaramid comprises poly(2,2′-disulfonyl-4,4′-benzidine terephthalamide) or a derivative thereof;
the ionic liquid comprises 1-butyl-1-methylpyrrolidinium bis(trifluoromethyl sulfonyl)imide;
the dopant comprises lithium bis(trifluoromethyl sulfonyl)imide;
the alkali salt additive comprises lithium difluorobis(oxalate) phosphate; and
the sulfur-containing polar aprotic solvent comprises sulfolane.

14. The composite electrolyte of claim 1, comprising
5 to 15 weight percent of the sulfonated polyaramid;
50 to 70 weight percent of the ionic liquid;
5 to 15 weight percent of the dopant;
1 to 5 weight percent of the alkali metal salt additive;
10 to 25 weight percent of a sulfur-containing polar aprotic solvent; and
1 to 15 weight percent of an oligoether compound;
wherein
the sulfonated polyaramid comprises poly(2,2′-disulfonyl-4,4′-benzidine terephthalamide) or a derivative thereof;
the ionic liquid comprises 1-butyl-1-methylpyrrolidinium bis(trifluoromethyl sulfonyl)imide;
the dopant comprises lithium bis(trifluoromethyl sulfonyl)imide;
the alkali metal salt additive comprises lithium difluorobis(oxalate) phosphate;
the sulfur-containing polar aprotic solvent comprises sulfolane; and
the oligoether compound comprises tetraethylene glycol dimethyl ether.

15. The composite electrolyte of claim 1, wherein the composite electrolyte has one or more of
an ionic conductivity of 1×10⁻⁶ to 1.5×10⁻² S/cm at 23° C.;
a storage modulus of 100 to 1000 MPa at 23° C.; and
a loss modulus of 10 to 100 MPa at 23° C.

16. A method of making the composite electrolyte of claim 1, the method comprising:
casting an aqueous solution comprising
the sulfonated polyaramid;
the ionic liquid;
the a dopant; and
the alkali metal salt additive;
to form a cast membrane; and
drying the cast membrane to provide the composite electrolyte.

17. A battery comprising:
an anode;
a cathode; and
the composite electrolyte of claim 1 disposed between the anode and the cathode.

18. The battery of claim 17, wherein the anode is a lithium metal anode and the cathode is LiNi_{0.8}Mn_{0.1}Co_{0.1}O₂.

19. The battery of claim 17, wherein the battery has one or more of
an initial discharge capacity of 150 to 250 mAh/g at a temperature of 60° C. and at C/3; or
a discharge capacity retention of at least 80%, or at least 85%, or at least 90% measured over 100 cycles or over 500 cycles at a temperature of 60° C. and at C/3; or
a limiting current density of greater than 0.5 mA cm⁻².

20. The battery of any of claim 17, wherein the battery is charged and discharged over a voltage range of 2.8 to 4.4 V.
